(19) United States
(12) Patent Application Publication
(10) Pub. No.: US 2026/0281431 A1
(43) Pub. Date: Sep. 17, 2026

(54) IMAGE CODING METHOD AND APPARATUS THEREFOR BASED ON MULTIPLE REFERENCE LINES

(71) Applicant: LX SEMICON CO., LTD., Daejeon (KR)

(72) Inventors: Jin Wook LEE, Daejeon (KR); Young Jun KIM, Daejeon (KR)

(73) Assignee: LX SEMICON CO., LTD., Daejeon (KR)

(21) Appl. No.: 19/565,027

(22) Filed: Mar. 12, 2026

(30) Foreign Application Priority Data
Mar. 13, 2025 (KR) 10-2025-0032432

(51) Int. Cl. H04N 19/593; H04N 19/117; H04N 19/176

(52) U.S. Cl. CPC H04N 19/593; H04N 19/117; H04N 19/176

(57) ABSTRACT

An image decoding method according to an embodiment of the present disclosure includes obtaining reference line selection information and intra prediction mode information through a bitstream, determining a reference line for a current block based on the reference line selection information, deriving an intra prediction mode for the current block based on the intra prediction mode information, and generating prediction samples for the current block based on the determined reference line and the intra prediction mode, wherein the reference line selection information indicates one or more reference line candidates among a plurality of reference line candidates.

### CROSS REFERENCE TO RELATED APPLICATION

The present application claims priority to Korean Patent Application No. 10-2025-0032432 filed on Mar. 13, 2025, the entire contents of which is incorporated herein for all purposes by this reference.

### BACKGROUND OF THE DISCLOSURE

### Field of the Disclosure

The disclosure relates to an image/video coding method and an image/video coding apparatus.

### Related Art

With an increasing use of multimedia data, the need for efficient video compression technology is rising. Video compression is essential for effectively transmitting high-quality image data within limited network bandwidth. To this end, various video codec technologies have been developed.

Video codec technologies include MPEG-2, H.264/AVC, H.265/HEVC, H.266/VVC, and AOMedia video 1 (AV1), which are expected to be widely utilized in diverse applications, such as Internet-based video streaming, video calls, virtual reality (VR), and augmented reality (AR).

As images/video reach high resolution and high quality, the data size of images/video expands, resulting in a relative increase in the amount of information or bits transmitted. Therefore, when transmitting image data using conventional media, such as wired and wireless broadband lines, or storing image/video data using existing storage media, costs for transmission and storage rise. To provide further improved compression efficiency image quality, there is a growing need for successor codec technologies, such as H.267 and AV2. In other words, high-efficiency image/video compression technology is required to effectively compress, transmit, store, and play high-resolution and high-quality image/video information.

### SUMMARY

According to an embodiment of the disclosure, there are provided a method and an apparatus for enhancing video/image coding efficiency.

According to an embodiment of the disclosure, there are provided a method and an apparatus for providing a next-generation high-quality video service.

According to an embodiment of the disclosure, there are provided a method and an apparatus for providing enhanced performance in a real-time streaming environment.

According to an embodiment of the disclosure, there are provided an intra prediction method and an intra prediction apparatus for video/image coding.

According to an embodiment of the disclosure, there is provided an image decoding method performed by a decoding apparatus. The method includes obtaining reference line selection information and intra prediction mode information through a bitstream, determining a reference line for a current block based on the reference line selection information, deriving an intra prediction mode for the current block based on the intra prediction mode information, and generating prediction samples for the current block based on the determined reference line and the intra prediction mode, wherein the reference line selection information indicates one or more reference line candidates among a plurality of reference line candidates.

According to an embodiment of the disclosure, there is provided an image encoding method performed by an encoding apparatus. The method includes determining a reference line for a current block, deriving an intra prediction mode for the current block, generating prediction samples for the current block based on the determined reference line and the intra prediction mode, generating reference line selection information related to the reference line, generating intra prediction mode information related to the intra prediction mode, and encoding image information including the reference line selection information and the intra prediction mode information, wherein the reference line selection information indicates one or more reference line candidates among a plurality of reference line candidates.

According to an embodiment of the disclosure, there is provided a decoding apparatus for image decoding. The decoding apparatus includes a memory and at least one processor connected to the memory, wherein the at least one processor is configured to perform an operation of obtaining reference line selection information and intra prediction mode information through a bitstream, determining a reference line for a current block based on the reference line selection information, deriving an intra prediction mode for the current block based on the intra prediction mode information, and generating prediction samples for the current block based on the determined reference line and the intra prediction mode, wherein the reference line selection information indicates one or more reference line candidates among a plurality of reference line candidates.

According to an embodiment of the disclosure, there is provided an encoding apparatus for image encoding. The encoding apparatus includes a memory and at least one processor connected to the memory, wherein the at least one processor is configured to perform an operation of determining a reference line for a current block, deriving an intra prediction mode for the current block, generating prediction samples for the current block based on the determined reference line and the intra prediction mode, generating reference line selection information related to the reference line, generating intra prediction mode information related to the intra prediction mode, and encoding image information including the reference line selection information and the intra prediction mode information, wherein the reference line selection information indicates one or more reference line candidates among a plurality of reference line candidates.

According to an embodiment of the disclosure, there is provided a method for storing or transmitting video/video data including a bitstream generated by a video/image encoding method according to at least one of embodiments of the disclosure.

According to an embodiment of the disclosure, there is provided an apparatus for storing or transmitting video/video data including a bitstream generated by a video/image encoding method according to at least one of embodiments of the disclosure.

According to an embodiment of the disclosure, there is provided a computer-readable storage medium that stores a program for performing a method according to at least one of the embodiments of the disclosure.

According to an embodiment of the disclosure, there is provided a computer-readable digital storage medium that stores encoded video/image information generated by a video/image encoding method according to at least one of embodiments of the disclosure.

According to an embodiment of the disclosure, there is provided a computer-readable digital storage medium that stores encoded information or encoded video/image information that causes a decoding apparatus to perform a video/image decoding method according to at least one of the embodiments of the disclosure.

According to an embodiment of the disclosure, overall video/image compression efficiency can be enhanced.

According to an embodiment of the disclosure, intra prediction efficiency can be enhanced.

According to an embodiment of the disclosure, neighboring reference samples of multiple reference lines may be efficiently derived in consideration of square/non-square shapes of a block.

According to an embodiment of the disclosure, intra prediction mode candidates may be determined in consideration of multiple reference lines, and intra prediction mode signaling may be efficiently performed.

According to an embodiment of the disclosure, a left line and a top line may be determined differently, and a reference line configuration therefor may be constructed.

According to an embodiment of the disclosure, filtering and/or prediction using two or more lines among multiple reference lines may be performed.

According to an embodiment of the disclosure, various reference lines may be efficiently used by setting reference line candidates differently according to conditions.

### BRIEF DESCRIPTION OF THE DRAWINGS

FIG. 1 schematically illustrates an example of a video/image coding system to which embodiments of the disclosure are applicable.

FIG. 2 is a diagram schematically illustrating a configuration of a video/image encoding apparatus to which embodiments of the disclosure are applicable.

FIG. 3 is a diagram schematically illustrating a configuration of a video/image decoding apparatus to which embodiments of the disclosure are applicable.

FIG. 4 illustrates an example of a partitioning structure according to an embodiment of the disclosure.

FIG. 5 illustrates an example of a partitioning structure considering recursive partitioning according to an embodiment of the disclosure.

FIG. 6 illustrates examples of partitioning candidates proposed in the disclosure.

FIG. 7 illustrates examples of partitioning candidates proposed in the disclosure.

FIG. 8 illustrates examples of partitioning candidates proposed in the disclosure.

FIG. 9 illustrates an example of a partitioning structure according to another embodiment of the disclosure.

FIG. 10 illustrates an example in which a coding block is located across a frame boundary.

FIG. 11 illustrates an example of signaling a semi-independent partitioning structure.

FIG. 12 illustrates an intra prediction procedure.

FIG. 13 illustrates examples of neighboring reference samples for intra prediction.

FIG. 14 illustrates directional intra prediction modes described in the disclosure.

FIG. 15 illustrates directional intra prediction modes extended based on an angle delta value.

FIG. 16 illustrates an example of multiple reference lines of neighboring reference samples for intra prediction.

FIG. 17 illustrates an example of multiple lines of neighboring reference samples for intra prediction.

FIG. 18 illustrates an example of configuring neighboring reference sample when a left line number and a top line number are determined differently.

FIG. 19 illustrates an example of generating a final prediction block through a weighted sum of two prediction blocks based on multiple reference lines according to an intra prediction mode.

FIG. 20 illustrates an example of generating an intra prediction sample through two-dimensional interpolation.

FIG. 21 illustrates an example of cross-line filtering for reference samples.

FIG. 22 illustrates an example of setting reference line candidates differently.

FIG. 23 illustrates another example of setting reference line candidates differently.

FIG. 24 schematically illustrates a video/image encoding method according to an embodiment(s) of the disclosure.

FIG. 25 schematically illustrates a video/image decoding method according to an embodiment(s) of the disclosure.

### DESCRIPTION OF EXEMPLARY EMBODIMENTS

As the disclosure may have various changes and various embodiments, specific embodiments are illustrated in the drawings and will be described in detail. However, it should be understood that there is no intent to limit embodiments of the disclosure to the specific embodiments. The terminology used herein is for the purpose of describing particular embodiments only and is not intended to limit the technical spirit of the disclosure. As used in the disclosure, singular forms are intended to include plural forms unless the context clearly indicates otherwise. As used herein, the term “and/or” includes any one and all combinations of two or more of the associated listed items. As used herein, the term “include,” “include,” and “have” specify the presence of stated features, numbers, operations, elements, components, and/or combinations thereof, but do not preclude the presence or addition of one or more other features, numbers, operations, elements, components, and/or combinations thereof. In the disclosure, the use of the term “may” in connection with an example or embodiment (e.g., regarding what an example or embodiment may include or implement) signifies that there is at least one example or embodiment in which such a feature is included or implemented, but all examples are not limited thereto and the corresponding feature or configuration may be omitted.

Each component of the drawings described in the disclosure is shown independently for the convenience of explaining distinct characteristic functions, which does not imply that each component is implemented as separate hardware or separate software. For example, two or more of these components may be combined to form a single component, or a single component may be divided into a plurality of components. Embodiments in which components are integrated and/or separated are also included within the scope of the disclosure without departing from the essence of the disclosure.

In the disclosure, “A or B” may mean “only A,” “only B,” or “both A and B.” In other words, “A or B” may be interpreted as “A and/or B” in the disclosure. For example, “A, B, or C” in the disclosure may mean “only A,” “only B,” “only C,” or “any and all combinations of A, B and C.”

A slash (/) or a comma as used herein may mean “and/or.” For example, “A/B” may mean “A and/or B.” Accordingly, “A/B” may mean “only A,” “only B,” or “both A and B.” For example, “A, B, C” may mean “A, B, or C.”

In the disclosure, “at least one of A and B” may mean “only A,” “only B,” or “both A and B.” Further, the expression “at least one of A or B” or “at least one of A and/or B” may be interpreted identically to “at least one of A and B.”

In the disclosure, “at least one of A, B and C” may mean “only A,” “only B,” “only C,” or “any and all combinations of A, B and C.” In addition, “at least one of A, B or C” or “at least one of A, B and/or C” may mean “at least one of A, B and C.”

Parentheses used in the disclosure may mean “for example.” Specifically, when indicated as “prediction (intra prediction),” “intra prediction” may be proposed as an example of “prediction.” In other words, “prediction” in the disclosure is not limited to “intra prediction,” and “intra prediction” may be proposed as an example of “prediction.” Furthermore, even when indicated as “prediction (i.e., intra prediction),” “intra prediction” may be proposed as an example of “prediction.”

In the disclosure, technical features individually explained within a single drawing may be implemented independently, or may be implemented simultaneously.

The disclosure relates to video/image coding. For example, a method/embodiment described in the disclosure may be applied to a method disclosed in an AOMedia Video 2 (AV2) standard. In addition, the method/embodiment disclosed herein may be applied to a method disclosed in an enhanced compression model, an H.267 standard, or a next-generation video/image coding standard (e.g., H.268 and H.269).

In the disclosure, coding may include encoding and/or decoding. In the disclosure, image coding may be used interchangeable with video coding.

In the disclosure, a video may refer to a set of a series of images over time. A frame generally refers to a unit representing a single image at a specific time, and a slice/tile refers to a unit forming a portion of a frame in coding. A slice/tile may include one or more superblock. A single frame may include one or more slices/tiles. A tile may represent a rectangular area of superblocks within a specific tile row and a specific tile column in a frame. A single frame may be divided into two or more subframes.

A pixel or a pel may mean a smallest unit forming one frame (or image). “Sample” may be used as a term corresponding to a pixel. A sample may generally represent a pixel or a pixel value, and may represent only a pixel/pixel value of a luma component or only a pixel/pixel value of a chroma component.

A unit may represent a basic unit of image processing. A unit may include at least one of a specific area of a frame and information related to the area. A single unit may include one luma block and two chroma (e.g., Cb and cr) blocks. A unit may be used interchangeably with terms such as a “block” or an “area” in some cases. In general, an M×N block may include a set (or array) of samples (or a sample array) or transform coefficients in M columns and N rows.

Hereinafter, embodiments of the disclosure will be described in detail with reference to the accompanying drawings. In addition, like reference numerals may be used to indicate like elements throughout the drawings, and redundant descriptions of the like elements may be omitted.

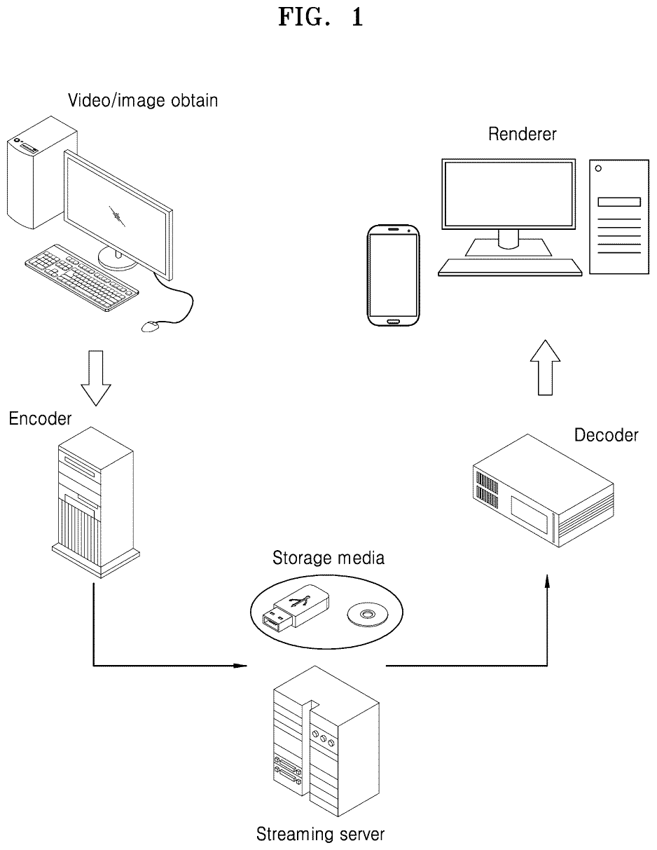

FIG. 1 schematically illustrates an example of a video/image coding system to which embodiments of the disclosure are applicable.

Referring to FIG. 1, the video/image coding system may include a first apparatus (encoding apparatus) and a second apparatus (decoding apparatus). The first apparatus may deliver encoded video/image information or data in a form of a file or streaming to the second apparatus via a digital storage medium or a network.

The video/image coding system may further include a video/image acquisition device and a video/image renderer. The video/image acquisition device may be included in the encoding apparatus, or may be configured as a separate device or an external component. The video/image renderer may be included in the decoding apparatus, or may be configured as a separate device or an external component.

The first apparatus may include a transmitter as an internal component, or as a separate device or an external component.

The second apparatus may include a receiver as an internal component, or as a separate device or an external component.

The encoding apparatus may be referred to as an encoder, and the decoding apparatus may be referred to as a decoder. The transmitter may be included in the encoding apparatus. The receiver may be included in the decoding apparatus. The renderer may include a display, and the display may be configured as a separate device or an external component.

The decoding apparatus and the encoding apparatus to which an embodiment(s) of the disclosure is applied may be included in a multimedia broadcasting transmission/reception device, a mobile communication terminal, a home cinema video device, a digital cinema video device, a surveillance camera, a video conversation device, a real-time communication device such as video communication, a mobile streaming device, a storage medium, a camcorder, a video-on-demand (VoD) service providing device, an over-the-top (OTT) video device, an Internet streaming service providing device, a three-dimensional (3D) video device, a virtual reality (VR) device, an augmented reality (AR) device, a video telephony device, a transportation terminal (e.g., a vehicle terminal (including an autonomous vehicle terminal), an aircraft terminal, and a vessel terminal), and a medical video device, and may be used to process a video signal or a data signal. For example, the over-the-top (OTT) video device may include a game console, a Blu-ray player, an Internet-connected TV, a home theater system, a smartphone, a tablet PC, and a digital video recorder (DVR).

The video/image acquisition device may obtain a video/image source. The video/image acquisition device may obtain a video/image through a process of capturing, synthesizing, or generating a video/image. The video/image acquisition device may include a video/image capture device and/or a video/image generation device. The video/image capture device may include, for example, one or more cameras and a video/image archive including previously captured video/images. The video/image generation device may include, for example, a camcorder, a computer, a tablet PC, and a smartphone, and may (electronically) generate a video/image. For example, a virtual video/image may be generated through a computer, in which case a video/image capture process may be replaced with a process of generating related data. The video/image source may perform a video/image preprocessing process to input an optimized video/image to the encoder.

The encoding apparatus may encode an input video/image. The encoding apparatus may encode an input video/image through an encoding method disclosed herein. The encoding apparatus may perform a series of procedures, such as prediction, transform, and quantization, for compression and coding efficiency. Encoded data (encoded video/image information) may be output in a form of a bitstream.

The transmitter may transmit encoded image/image information or data output in a form of a bitstream to the receiver of the receiving device in a form of a file or streaming through the digital storage medium or the network. The encoded image/image information or data output in the form of the bitstream may be transmitted to the receiver through a streaming server. The digital storage medium may include various storage mediums, such as a USB, an SD, a CD, a DVD, a Blu-ray, an HDD, and an SSD. The transmitter may include an element for generating a media file through a predetermined file format, and may include an element for transmission through a broadcast/communication network. The receiver may receive/extract the bitstream and transmit the received bitstream to the decoding apparatus. In the disclosure, the transmitter may be referred to as a transmitting apparatus, and the receiver may be referred to as a receiving apparatus. As image/video resolution and quality become higher, the raw data size of images/videos is increasing. By obtaining and storing/transmitting a bitstream (or data including the bitstream) generated by an efficient encoding method according to the disclosure, it is possible to increase storage/transmission efficiency and support low-latency/real-time transmission.

The streaming server may temporarily store the bitstream during a process of transmitting or receiving the bitstream. The streaming server transmits multimedia data to a user device, based on a user request via a web server, and the web server serves as an intermediary for informing a user of an available service. When the user requests a desired service from the web server, the web server transmits the request to the streaming server, and the streaming server transmits multimedia data to the user. The content streaming system may include a separate control server, in which case the control server controls a command/response between devices in the content streaming system.

The streaming server may receive content from a media storage and/or the encoding apparatus. For example, when receiving content from the encoding apparatus, the content may be received in real time. In this case, the streaming server may store the bitstream for a certain time to provide a smooth streaming service.

The decoding apparatus may decode the video/image by performing a series of procedures, such as dequantization, inverse transform, and prediction, corresponding to an operation of the encoding apparatus. The decoding apparatus may decode a video/image through a decoding method disclosed herein.

The renderer may render the decoded video/image. The rendered video/image may be displayed on the display.

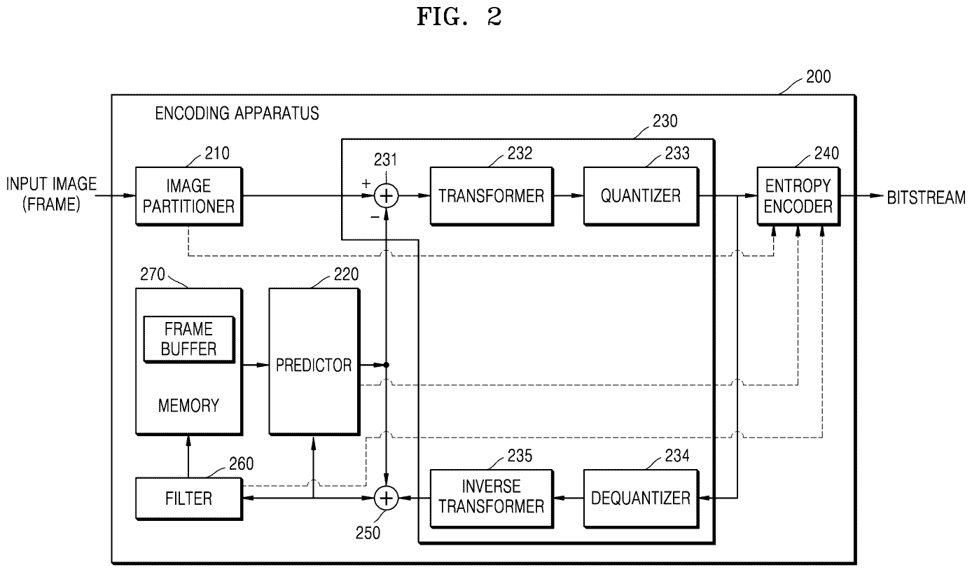

FIG. 2 is a diagram schematically illustrating a configuration of a video/image encoding apparatus to which embodiments of the disclosure are applicable. Hereinafter, an encoding apparatus may include an image encoding apparatus and/or a video encoding apparatus.

Referring to FIG. 2, the encoding apparatus 200 may include an image partitioner 210, a predictor 220, a residual processor 230, and an entropy encoder 240, an adder 250, a filter 260, and a memory 270. The predictor 220 may include an inter predictor and an intra predictor. The residual processor 230 may include a transformer 232, a quantizer 233, a dequantizer 234, and an inverse transformer 235. The residual processor 230 may further include a subtractor 231. The adder 250 may be referred to as a reconstructor or a reconstructed block generator. The image partitioner 210, the predictor 220, the residual processor 230, the entropy encoder 240, the adder 250, and the filter 260 may be configured as at least one hardware component (e.g., an encoder chipset or processor) according to an embodiment. The memory 270 may include a frame buffer, or may be configured as a digital storage medium. The hardware component may further include the memory 270 as an internal/external component.

The image partitioner 210 may partition an input image (or a picture or a frame) input to the encoding apparatus 200 into one or more processing unit. For example, the processing unit may include a superblock or a coding unit (CU). A frame may be partitioned into a plurality tiles. A tile may have a rectangular shape. Uniform or non-uniform tile sizes may be determined on a per-frame basis. In the disclosure, the terms “frame” and “picture” may be used interchangeably. A tile may include an integer number of superblocks. Superblocks within a tile may be coded in raster scan order. A superblock may be partitioned into one or more coding blocks. For example, a superblock may have a size of 128×128 or 64×64 based on a luma component. Alternatively, a superblock may have a size of 256×256 based on the luma component. A superblock may have a dependency only on specific neighboring superblocks. For example, a superblock may have a dependency only on left and/or upper neighboring superblocks.

A superblock may be recursively partitioned. For example, a superblock may be derived as a single coding block, or a superblock may be partitioned into coding blocks, based on a binary tree, a ternary tree, or a quad tree. One coding block may be recursively partitioned into a plurality of coding blocks of a deeper depth, based on a binary tree, a ternary tree, or a quad tree. For example, when a coding block is partitioned into PARTITION_N×N, recursive partitioning may be possible. A coding procedure according to the disclosure may be performed based on a final coding block that is no longer partitioned. In this case, a superblock may be directly used as the final coding block, based on coding efficiency according to video characteristics. Alternatively, a coding block may be recursively partitioned into deeper-depth coding blocks as needed so that a coding block with an optimal size may be used as the final coding block. Here, the coding procedure may include procedures such as prediction, transform, and reconstruction, which will be described later. The processing unit may further include a prediction block (PB) or a transform block (TB). In this case, the prediction block or the transform block may be split or partitioned from the final coding block described above. For example, a single transform block of the same size as the coding block may be derived, or a plurality of transform blocks may be derived from the coding block, based on a quad tree or binary tree. The transform block may be recursively partitioned into deeper-depth transform blocks. The prediction block may be a unit for prediction (or for deriving a prediction mode), and the transform block may be a unit for performing a transform, a unit for deriving a transform coefficient, and/or a unit for deriving a residual signal from a transform coefficient. For example, prediction mode derivation for intra prediction may be performed on a coding block basis or a prediction block basis, and prediction sample derivation through an intra prediction procedure may be performed on a transform block basis. A block to be currently processed according to a coding order may be referred to as a current block.

The term “block” may be used interchangeably with the term “unit” or “area” depending on a case. In general, an M×N block may denote an array of samples or transform coefficients arranged in M rows and N columns. A sample may generally denote a pixel or a pixel value, and may represent only a pixel/pixel value of a luma component or only a pixel/pixel value of a chroma component. A “sample” may be used as a term corresponding to a pixel or pel of a frame (or image).

The encoding apparatus 200 may generate a residual signal (residual signal, residual block, or residual sample array) by subtracting a prediction signal (predicted block or predicted sample array) output from the predictor from an input image signal (original block or original sample array), and the generated residual signal is transmitted to the transformer 232. In this case, as illustrated, a component for subtracting the prediction signal (predicted block or predicted sample array) from the input image signal (original block or original sample array) in the encoder 200 may be referred to as the subtractor 231. The predictor may perform prediction on a processing target block (hereinafter, referred to as a current block), and may generate a predicted block including prediction samples for the current block. The predictor may determine whether intra prediction or inter prediction is applied on a current block or coding block basis. The predictor may generate various pieces of information about prediction, such as prediction mode information, and may transmit the generated information to the entropy encoder 240, as described below in a description of each prediction mode. The information about prediction may be encoded by the entropy encoder 240 and output in a form of a bitstream.

The intra predictor may predict the current block with reference to samples within a current frame. The referenced samples may be located adjacent to (neighboring) the current block, or may be located away from the current block depending on a prediction mode. Intra prediction may be performed on a transform block basis. When a plurality of transform blocks exists in a coding block, intra prediction may be performed sequentially in a raster order of the transform blocks. In this case, a procedure for deriving neighboring reference samples for intra prediction may be performed based on a transform block. A plurality of prediction modes may be considered for intra prediction. The prediction modes may include a plurality of non-directional modes and a plurality of directional modes. A prediction mode used for the current block may be signaled from the encoding apparatus to a decoding apparatus, and the prediction modes may include, for example, a DC intra prediction mode, a plurality of directional intra prediction modes, a plurality of SMOOTH intra prediction modes, and/or a PAETH intra prediction mode. The prediction modes may include an intra block copy (intrabc) mode. Whether the intra block copy mode is applied may be signaled separately. The directional prediction modes may include, for example, eight or more prediction modes depending on a prediction direction, which is, however, only for illustration, and a greater or smaller number of directional prediction modes may be used depending on a configuration. The intra predictor may also determine a prediction mode to be applied to the current block, based on a prediction mode applied to a neighboring block. In the intra block copy mode, similar to an inter prediction mode described below, a reference block is derived based on a vector, and the current frame is used as a reference frame. The vector used to derive the reference block in the intra block copy mode may be referred to as a block vector.

The inter predictor may induce a predicted block for the current block, based on a reference block (reference sample array) specified by a motion vector on a reference picture. Here, to reduce the amount of motion information transmitted in the inter prediction mode, motion information may be predicted on a block, sub-block, or sample basis, based on a correlation in motion information between a neighboring block and the current block. The motion information may include a motion vector and/or a reference frame index. The motion information may further include inter prediction direction (L0 prediction, L1 prediction, and compound prediction) information. In inter prediction, the neighboring block may include a spatial neighboring block existing within a current frame and a temporal neighboring block existing in the reference frame. A reference frame including the reference block and the reference frame including the temporal neighboring block may be the same or different. The temporal neighboring block may be referred to as a co-located reference block or a co-located block (colblock), and the reference frame including the temporal neighboring block may also be referred to as a co-located frame (colframe). For example, the inter predictor may configure a motion information stack, based on neighboring blocks, and may generate information indicating a candidate used to derive the motion vector and/or the reference frame index of the current block. The motion information stack may be referred to as a motion information list. The motion information stack may include a motion vector stack. The motion vector stack may be referred to as RefStackMv. The motion vector stack may include eight or more candidates. Information about the (maximum) number of candidates of the motion vector stack may be signaled on a frame or sequence basis. For inter prediction, a motion mode may be additionally considered. The motion mode may include a simple mode, an overlapped block motion compensation (OBMC) mode and/or a local warp mode. The OBMC mode may improve prediction performance by using motion information about a neighboring block at a left and/or upper boundary of the current block, and the local warp mode may apply an affine model in addition to translational motion compensation.

A motion vector may be derived based on various prediction modes. For example, in an NEWMV mode, a motion vector of the current block may be indicated based on a motion vector of a reference stack and a motion vector difference. If needed, in the NEWMV mode, the motion vector of the current block may be indicated based on the motion vector difference without the motion vector of the reference stack. Information about the motion vector difference may be generated by the encoding apparatus and signaled to the decoding apparatus. A ZEROMV mode may indicate that a zero vector or a default vector is used as the motion vector of the current block. An REFMV mode may indicate that a motion vector of the motion information stack is used as the motion vector of the current block. However, these designations are only examples, and the motion vector of the current block may be indicated by various other names. For example, a GLOBALMV mode may indicate that global motion information is used for the current block. For example, an NEARSTMV mode may indicate that a first candidate (candidate at index 0) of the motion information stack is used for the current block. For example, an NEARMV mode may indicate that a specific candidate (indicated by refMVidx) of the motion information stack is used for the current block. However, the above mode names are examples, and other names, such as mode 1 and mode 2, may be used if needed.

When compound prediction is applied, inter prediction may be performed using both reference frame lists L0 and L1. In this case, a motion vector for an L0 direction and a motion vector for an L1 direction may be derived. Furthermore, an L0 reference frame for the L0 direction and an L1 reference frame for the L1 direction may be derived. If needed, a first motion vector and a second motion vector may be used instead of an L0 motion vector and an L1 motion vector, respectively. If needed, a first reference frame and a second reference frame may be used instead of the L0 reference frame and the L1 reference frame, respectively.

The predictor 220 may generate a prediction signal, based on various prediction methods. For example, the predictor may apply intra prediction or inter prediction for prediction of one block, and may simultaneously apply intra prediction and inter prediction, which may be referred to as compound inter-intra prediction. In this case, a mode used for the intra prediction may include the DC prediction mode, a vertical prediction mode, a horizontal prediction mode, and the SMOOTH prediction mode. Further, the predictor may be based on the intra block copy mode described above or a palette mode for the prediction of the block. As described above, the intra block copy mode is a type of intra prediction and basically performs prediction within the current frame, but may be performed similarly to inter prediction in that the mode derives a reference block, based on a vector using the current frame as a reference frame. However, since the current frame is used as the reference frame, the term “block vector” may be used for a vector for displacement instead of “motion vector”. That is, the intra block copy mode may utilize at least one of inter prediction techniques described in the disclosure. In this case, a motion vector derived through a neighboring block or the motion information stack may be referenced for deriving a block vector of the current block. For example, when the intra block copy mode is applied, the foregoing NEWMV mode may be used for deriving the block vector of the current block.

The prediction signal generated by the predictor 220 may be used to generate a reconstructed signal or to generate a residual signal. The transformer 232 may generate transform coefficients by applying a transform technique to the residual signal. For example, the transform technique may include at least one of a discrete cosine transform (DCT), a discrete sine transform (DST), a Karhunen-Loeve transform (KLT), a graph-based transform (GBT), or a conditionally non-linear transform (CNT). Further, the transform technique may include, for example, a DCT, asymmetric discrete sine transform (ADST), a flipped ADST (FLIPADST), an identity transform (IDTX), a Walsh-Hadamard transform (WHT), a V_DCT, and an H_DCT. The DCT is one of the most widely used transformation techniques in image compression, primarily transforming image signals into a frequency domain to concentrate energy into low-frequency components. The ADST is similar to the DCT, but is designed to smoothly connect signals at block boundaries. The FLIPADST is a modified version of the ADST that applies a transform in a reversed direction, enabling more efficient signal compression for a specific block pattern. The IDTX is an identity transformation method that maintains a signal without any transformation. The identity transform may be applied to either a vertical transform or a horizontal transform, or both. For example, when a transformation method is specified for only one of the vertical and horizontal transforms, the identity transform may be implicitly applied to the other transform. The WHT is a linear transform similar to a discrete Fourier transform (DFT) or discrete cosine transform (DCT), representing signals or data by transforming the same into a different basis. The WHT may use an orthogonal basis matrix including +1 and −1 instead of using a trigonometric function (sine and cosine). The V_DCT and the H_DCT indicate that the DCT transform is performed in the vertical direction of a block and the DCT transform is performed in the horizontal direction of the block, respectively. For example, for a simple block, the DCT may be used to increase a compression ratio, while the ADST or FLIPADST may be used when smooth transitions are required at boundaries. For a block where a signal remains nearly unchanged, the IDTX may be applied.

The quantizer 233 may quantize the transform coefficients and transmit the same to the entropy encoder 240, and the entropy encoder 240 may encode a quantized signal (information about the quantized transform coefficients) and output the encoded signal as a bitstream. The information about the quantized transform coefficients may be referred to as residual information. The quantizer 233 may rearrange the quantized transform coefficients in a block form into a one-dimensional vector form, based on a coefficient scan order, and may generate the information about the transform coefficients, based on the quantized transform coefficients in the one-dimensional vector form. The entropy encoder 240 may perform various encoding methods, for example, a cumulative distribution function and context-adaptive binary arithmetic coding (CABAC). The CDF is a method of storing cumulative values of a probability distribution, allowing symbols to be represented with fewer bits compared to storing probabilities directly. Within the CDF, symbol probabilities may be adaptively adjusted based on context. The entropy encoder 240 may encode information (e.g., values of syntax elements) necessary for video/image reconstruction other than the quantized transform coefficients together or separately. The encoded information (e.g., encoded video/image information) may be packetized on an open bitstream unit (OBU) basis in a form of a bitstream and be transmitted or stored. The video/image information may further include information commonly applied to a specific range, such as a tile header, a frame header, and a sequence header. In the disclosure, information and/or syntax elements transmitted/signaled from the encoding apparatus to the decoding apparatus may be included in the video/image information. The video/image information may be encoded through the foregoing encoding procedure and included in the bitstream. The bitstream may be transmitted through a network, or may be stored in a digital storage medium. The network may include a broadcasting network and/or a communication network, and the digital storage medium may include various storage media, such as a USB, an SD, a CD, a DVD, a Blu-ray, an HDD, and an SSD. A transmitter (not shown) and/or a storage (not shown) for transmitting and/or storing a signal output from the entropy encoder 240 may be configured as internal/external elements of the encoding apparatus 200, or the transmitter may be included in the entropy encoder 240.

The quantized transform coefficients output from the quantizer 233 may be used to generate a prediction signal. For example, the residual signal (residual block or residual samples) may be reconstructed by applying dequantization and inverse transform to the quantized transform coefficients through the dequantizer 234 and the inverse transform unit 235. The adder 250 may add the reconstructed residual signal to the prediction signal output from the predictor to generate a reconstructed signal (reconstructed frame, reconstructed block, or reconstructed sample array). When there is no residual for the processing target block, such as when a skip mode is applied, the predicted block may be used as a reconstructed block. The adder 250 may be referred to as a reconstructor unit or a reconstructed block generator. The generated reconstructed signal may be used for intra prediction of a next processing target block in the current frame, or may be used for inter prediction of a next frame after being filtered as described below.

The filter 260 may improve subjective/objective image quality by applying filtering to the reconstructed signal. For example, the filter 260 may generate a modified reconstructed frame by applying various filtering methods to the reconstructed frame, and may store the modified reconstructed frame in the memory 270, specifically, in the frame buffer of the memory 270. The various filtering methods may include, for example, deblocking filtering, a sample adaptive offset, an adaptive loop filter, and a bilateral filter. The filter 260 may generate information related to the filtering, and may transmit the generated information to the entropy encoder 240. The information related to the filtering may be encoded by the entropy encoder 240 and output in a form of a bitstream.

The modified reconstructed frame transmitted to the memory 270 may be used as a reference frame in the inter predictor. When inter prediction is applied via the modified reconstructed frame, the encoding apparatus may avoid a prediction mismatch between the encoding apparatus 200 and the decoding apparatus, and may improve encoding efficiency may be improved.

The memory 270 may store the modified reconstructed frame for use as the reference frame in the inter predictor. The memory 270 may store motion information about a block from which motion information in the current frame is derived (or encoded) and/or motion information about blocks in a frame already reconstructed. The stored motion information may be transmitted to the inter predictor to be utilized as motion information about the spatial neighboring block or motion information about the temporal neighboring block. The memory 270 may store reconstructed samples of reconstructed blocks in the current frame, and may transmit the reconstructed samples to the intra predictor.

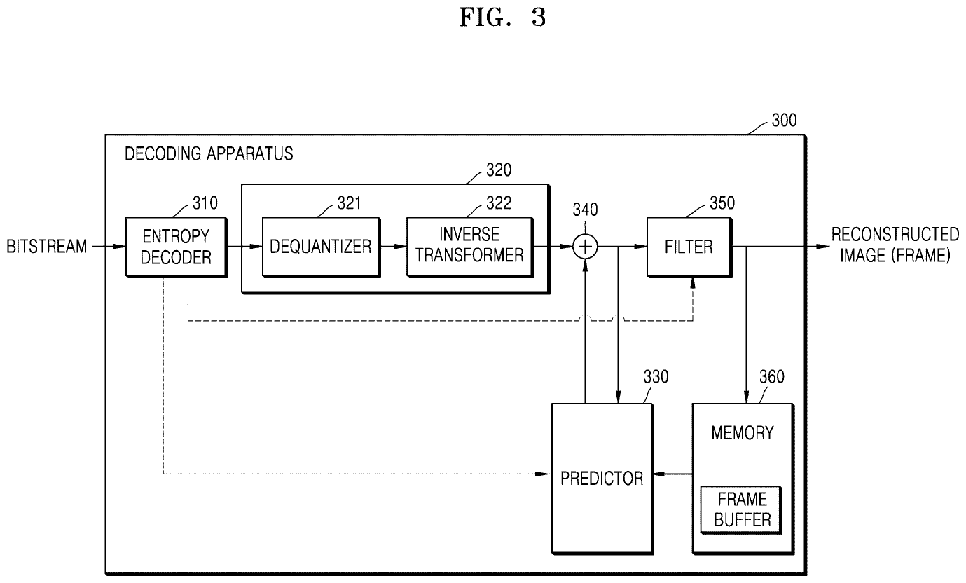

FIG. 3 is a diagram schematically illustrating a configuration of a video/image decoding apparatus to which embodiments of the disclosure are applicable. Hereinafter, a decoding apparatus may include an image decoding apparatus and/or a video decoding apparatus.

Referring to FIG. 3, the decoding apparatus 300 may include an entropy decoder 310, a residual processor 320, a predictor 330, an adder 340, a filter 350, and a memory 360. The predictor 330 may include an inter predictor and an intra predictor. The residual processor 320 may include a dequantizer 321 and an inverse transformer 322. The entropy decoder 310, the residual processor 320, the predictor 330, the adder 340, and the filter 350 may be configured as a single hardware component (e.g., a decoder chipset or processor) according to an embodiment. The memory 360 may include a frame buffer, and may be configured as a digital storage medium. The hardware component may further include the memory 360 as an internal/external component.

When a bitstream including video/image information is input, the decoding apparatus 300 may reconstruct an image according to a process in which the video/image information is processed in the encoding apparatus of FIG. 2. For example, the decoding apparatus 300 may derive units/blocks, based on block partition-related information obtained from the bitstream. The decoding apparatus 300 may perform decoding using a processing unit applied to the encoding apparatus. Therefore, the processing unit for decoding may be, for example, a superblock or a coding unit, and a coding unit may be partitioned from a superblock according to a quad-tree structure, a binary-tree structure, and/or a ternary-tree structure. One or more prediction blocks or transform units may be derived from a coding unit. A reconstructed image signal decoded and output by the decoding apparatus 300 may be reproduced via a reproducing apparatus.

The decoding apparatus 300 may receive a signal output from the encoding apparatus in a form of a bitstream, and the received signal may be decoded by the entropy decoder 310. For example, the entropy decoder 310 may parse the bitstream to derive information (e.g., video/image information) necessary for image reconstruction (or frame reconstruction). The video/image information may further include information commonly applied to a specific range, such as a tile header, a frame header, and a sequence header. The decoding apparatus may decode a frame, based on the header information. In the disclosure, signaled/received information and/or syntax elements to be described below may be decoded through the decoding procedure and may be obtained from the bitstream. For example, the entropy decoder 310 may decode the information in the bitstream, based on a coding method, such as a CDF and CABAC, and may output a value of a syntax element required for image reconstruction and a quantized value of a transform coefficient for a residual. More specifically, the CDF-based coding method may include a procedure of storing a probability distribution of symbols in a form of a CDF, selecting an appropriate CDF by analyzing context of a current block, encoding symbols at an encoder side, based on the CDF, and reconstructing syntax elements/information using the same CDF at a decoder side. The CABAC method may determine a context model by using a target syntax element/information and coding information about neighboring and coding target blocks or information about a symbol/bin coded in a previous stage, generate a bit string by predicting an occurrence probability of a bin according to the determined context model and performing arithmetic encoding on the bin at the encoder side, and generate a symbol corresponding to a value of each syntax element by predicting an occurrence probability of a bin according to the determined context model and performing arithmetic decoding on the bin at the decoder side. Here, after determining the context model, the context model may be updated using information about a coded symbol/bin for a context model of a next symbol/bin. Prediction-related information among the information decoded by the entropy decoder 310 may be provided to the predictor 330, and a residual value obtained through entropy decoding in the entropy decoder 310, that is, quantized transform coefficients and related parameter information, may be input to the residual processor 320. The residual processor 320 may derive a residual signal (residual block, residual samples, or residual sample array). Filtering-related information among the information decoded by the entropy decoder 310 may be provided to the filter 350. A receiver (not shown) for receiving a signal output from the encoding apparatus may be further configured as an internal/external element of the decoding apparatus 300, or the receiver may be a component of the entropy decoder 310. The decoding apparatus according to the disclosure may be referred to as a video/image/frame decoding apparatus, and may be divided into an information decoder (video/image/frame information decoder) and a sample decoder (video/image/frame sample decoder). The information decoder may include the entropy decoder 310, and the sample decoder may include at least one of the dequantizer 321, the inverse transformer 322, the adder 340, the filter 350, the memory 360, and the predictor 330.

The dequantizer 321 may dequantize the quantized transform coefficients to output transform coefficients. The dequantizer 321 may rearrange the quantized transform coefficients in a two-dimensional block form. In this case, the rearrangement may be performed based on a coefficient scan order executed in the encoding apparatus. The dequantizer 321 may perform dequantization on the quantized transform coefficients using a quantization parameter (e.g., quantization step size information), and obtain the transform coefficients.

The inverse transformer 322 inversely transforms the transform coefficients to acquire a residual signal (residual block or residual sample array).

The predictor may perform prediction of the current block, and may generate a predicted block including prediction samples of the current block. The predictor may determine whether intra prediction is applied or inter prediction is applied to the current block, based on the prediction-related information output from the entropy decoder 310, and determine a specific intra/inter prediction mode.

The predictor 330 may generate a prediction signal, based on various prediction methods. For example, the predictor may apply intra prediction or inter prediction for prediction of one block, and may simultaneously apply intra prediction and inter prediction, which may be referred to as compound inter-intra prediction. In this case, a mode used for the intra prediction may include the DC prediction mode, a vertical prediction mode, a horizontal prediction mode, and the SMOOTH prediction mode. Further, the predictor may be based on the intra block copy mode described above or a palette mode for the prediction of the block. As described above, the intra block copy mode is a type of intra prediction and basically performs prediction within a current frame, but may be performed similarly to inter prediction in that the mode derives a reference block, based on a vector using the current frame as a reference frame. However, since the current frame is used as the reference frame, the term “block vector” may be used for a vector for displacement instead of “motion vector”. That is, the intra block copy mode may utilize at least one of inter prediction techniques described in the disclosure. In this case, a motion vector derived through a neighboring block or the motion information stack may be referenced for deriving a block vector of the current block. For example, when the intra block copy mode is applied, the foregoing NEWMV mode may be used for deriving the block vector of the current block.

The intra predictor may predict the current block with reference to samples within a current frame. The referenced samples may be located adjacent to (neighboring) the current block, or may be located away from the current block depending on a prediction mode. Intra prediction may be performed on a transform block basis. When a plurality of transform blocks exists in a coding block, intra prediction may be performed sequentially in a raster order of the transform blocks. In this case, a procedure for deriving neighboring reference samples for intra prediction may be performed based on a transform block. A plurality of prediction modes may be considered for intra prediction. The prediction modes may include a plurality of non-directional modes and a plurality of directional modes. A prediction mode used for the current block may be signaled from the encoding apparatus to a decoding apparatus, and the prediction modes may include, for example, a DC intra prediction mode, a plurality of directional intra prediction modes, a plurality of SMOOTH intra prediction modes, and/or a PAETH intra prediction mode. The prediction modes may include an intra block copy (intrabc) mode. Whether the intra block copy mode is applied may be signaled separately. The directional prediction modes may include, for example, eight or more prediction modes depending on a prediction direction, which is, however, only for illustration, and a greater or smaller number of directional prediction modes may be used depending on a configuration. The intra predictor may also determine a prediction mode to be applied to the current block, based on a prediction mode applied to a neighboring block. In the intra block copy mode, similar to an inter prediction mode described below, a reference block is derived based on a vector, and the current frame is used as a reference frame. The vector used to derive the reference block in the intra block copy mode may be referred to as a block vector. Intra prediction may be performed based on various prediction modes, and the prediction-related information obtainable through the bitstream may include information indicating an intra prediction mode for the current block.

The inter predictor may induce a predicted block for the current block, based on a reference block (reference sample array) specified by a motion vector on a reference picture. Here, to reduce the amount of motion information transmitted in the inter prediction mode, motion information may be predicted on a block, sub-block, or sample basis, based on a correlation in motion information between a neighboring block and the current block. The motion information may include a motion vector and/or a reference frame index. The motion information may further include inter prediction direction (L0 prediction, L1 prediction, and compound prediction) information. In inter prediction, the neighboring block may include a spatial neighboring block existing within a current frame and a temporal neighboring block existing in the reference frame. A reference frame including the reference block and the reference frame including the temporal neighboring block may be the same or different. The temporal neighboring block may be referred to as a co-located reference block or a co-located block, and the reference frame including the temporal neighboring block may also be referred to as a co-located frame. For example, the inter predictor may configure a motion information stack, based on neighboring blocks, and may generate information indicating a candidate used to derive the motion vector and/or the reference frame index of the current block. The motion information stack may be referred to as a motion information list. The motion information stack may include a motion vector stack. The motion vector stack may be referred to as RefStackMv. The motion vector stack may include eight or more candidates. Information about the (maximum) number of candidates of the motion vector stack may be signaled on a frame or sequence basis. For inter prediction, a motion mode may be additionally considered. The motion mode may include a simple mode, an overlapped block motion compensation (OBMC) mode and/or a local warp mode. The OBMC mode may improve prediction performance by using motion information about a neighboring block at a left and/or upper boundary of the current block, and the local warp mode may apply an affine model in addition to translational motion compensation. Inter prediction may be performed based on various prediction modes, and the prediction-related information obtainable through the bitstream may include information indicating an inter prediction mode for the current block. For example, the inter predictor may configure a motion information stack, based on neighboring blocks, and may derive a motion vector and/or a reference frame index of the current block, based on received candidate selection information (e.g., a reference motion vector index and/or a reference frame index).

The adder 340 may add the obtained residual signal to the prediction signal (predicted block or prediction same array) output from the predictor 330 to generate a reconstructed signal (reconstructed frame, reconstructed block, or reconstructed sample array). When there is no residual for the processing target block, such as when a skip mode is applied, the predicted block may be used as a reconstructed block.

The adder 340 may be referred to as a reconstructor unit or a reconstructed block generator. The generated reconstructed signal may be used for intra prediction of a next processing target block in the current frame, or may be output or used for inter prediction of a next frame after being filtered as described below.

The filter 350 may improve subjective/objective image quality by applying filtering to the reconstructed signal. For example, the filter 350 may generate a modified reconstructed frame by applying various filtering methods to the reconstructed frame, and may transmit the modified reconstructed frame to the memory 360, specifically, to the frame buffer of the memory 360. The various filtering methods may include, for example, deblocking filtering, a sample adaptive offset, an adaptive loop filter, and a bilateral filter.

The (modified) reconstructed frame stored in the memory 360 may be used as a reference frame in the inter predictor. The memory 360 may store motion information about a block from which motion information in the current frame is derived (or decoded) and/or motion information about blocks in a frame already reconstructed. The stored motion information may be transmitted to the inter predictor to be utilized as motion information about the spatial neighboring block or motion information about the temporal neighboring block. The memory 360 may store reconstructed samples of reconstructed blocks in the current frame, and may transmit the reconstructed samples to the intra predictor.

In this specification, the embodiments described for each component of the encoding apparatus 200 may also be applied equally or correspondingly to the corresponding components of the decoding apparatus 300.

As described above, in performing video coding, prediction is conducted to increase compression efficiency. Through the prediction, a predicted block including prediction samples for a current block, which is a coding target block, may be generated. The predicted block includes the prediction samples in a spatial domain (or pixel domain). The predicted block is derived identically in an encoding apparatus and a decoding apparatus, and the encoding apparatus may enhance image coding efficiency by signaling information about a residual between an original block and the predicted block (residual information), rather than an original sample value of the original block, to the decoding apparatus. The decoding apparatus may derive a residual block including residual samples, based on the residual information, may generate a reconstructed block including reconstructed samples by combining the residual block and the predicted block, and may generate a reconstructed frame including the reconstructed blocks.

The residual information may be generated through transform and quantization procedures. For example, the encoding apparatus may derive a residual block between the original block and the predicted block, may perform a transform procedure on residual samples (a residual sample array) included in the residual block to derive transform coefficients, and may perform a quantization procedure on the transform coefficients to derive quantized transform coefficients, and may signal the related residual information to the decoding apparatus (via a bitstream). The residual information may include information, such as value information and position information about the quantized transform coefficients, a transform technique, a transform kernel, and a quantization parameter. The decoding apparatus may perform a dequantization/inverse transform procedure based on the residual information to derive the residual samples (or residual block). The decoding apparatus may generate a reconstructed frame, based on the predicted block and the residual block. The encoding apparatus may perform a dequantization/inverse transform on the quantized transform coefficients to derive the residual block for reference in inter prediction of a subsequent frame, and may generate a reconstructed frame, based on the residual block.

In the disclosure, at least one of quantization/dequantization and/or transform/inverse transform may be omitted. When the quantization/dequantization is omitted, the quantized transform coefficients may be referred to as transform coefficients. When the transform/inverse transform is omitted, the transform coefficients may be referred to as coefficients or residual coefficients, or may still be referred to as transform coefficients for consistency in expression.

Further, in the disclosure, a quantized transform coefficient and a transform coefficient may be referred to as a transform coefficient and a scaled transform coefficient, respectively. In this case, residual information may include information about a transform coefficient(s), and the information about the transform coefficient(s) may be signaled via residual coding syntax. Transform coefficients may be derived based on the residual information (or information about the transform coefficient(s)), and scaled transform coefficients may be derived through inverse transform (scaling) of the transform coefficients. Residual samples may be derived based on inverse transform (transform) of the scaled transform coefficients. These details may be equally applied or described in other parts of the disclosure.”

A video/image coding method according to the disclosure may be performed based on a partitioning structure. Specifically, procedures such as prediction, residual processing (inverse transform and (de) quantization), syntax element coding, and in-loop filtering may be performed based on a superblock, a coding block, or a transform block derived based on the partitioning structure. A block partitioning procedure may be performed in the image partitioner of the encoding apparatus described above, and partition information may be processed (encoded) by the entropy encoder and transmitted in a form of a bitstream to the decoding apparatus. The entropy decoder of the decoding apparatus may derive a block partitioning structure of a frame, based on the partition information obtained from the bitstream, and may perform a series of decoding procedures (e.g., prediction, residual processing, block/picture reconstruction, and in-loop filtering), based on the block partitioning structure. The partition information may be referred to as split information.

As described above, a bitstream may be packetized through open bitstream units (OBUs). A single frame may be partitioned into one or more rectangular-shaped tiles. Tile-related information may be signaled from the encoding apparatus to the decoding apparatus. For example, the tile-related information may be signaled through tile group OBU syntax. Uniform/non-uniform tile sizes may be determined on a per-frame basis and signaled from the encoding apparatus to the decoding apparatus. For example, information about a tile size may be transmitted at a frame header level, or signaled through the aforementioned tile group OBU syntax.

A single image or frame may be partitioned into superblock units. Based on a luma component, a superblock may have a size of, for example, 64×64, 128×128, or 256×256. A superblock of a chroma component may have a size equal to or smaller than the superblock for the luma component. For example, considering a color format of 4:2:0, the superblock of the chroma component may have a size of, for example, 32×32, 64×64, or 128×128. However, the aforementioned superblock sizes are merely for illustration, and larger or smaller block sizes are also possible. A tile includes superblocks, and the superblocks within the tile may be arranged in raster scan order.

According to an embodiment of the disclosure, starting from a superblock, a coding block may be partitioned based on various partitioning structures.

The following table illustrates examples of partitioning structures.

TABLE 1

| Partition | Name of Partition |
|---|---|
| 0 | PARTITION_NONE |
| 1 | PARTITION_HORZ |
| 2 | PARTITION_VERT |
| 3 | PARTITION_SPLIT |
| 4 | PARTITION_HORZ_A |
| 5 | PARTITION_HORZ_B |
| 6 | PARTITION_VERT_A |
| 7 | PARTITION_VERT_B |
| 8 | PARTITION_HORZ_4 |
| 9 | PARTITION_VERT_4 |

PARTITION_NONE indicates that a superblock or coding block is not further partitioned into smaller coding blocks. PARTITION_HORZ indicates that a superblock or coding block is binary-partitioned in the horizontal direction. PARTITION_VERT indicates that a superblock or coding block is binary-partitioned in the vertical direction. PARTITION_SPLIT indicates that a superblock or coding block is quad-tree partitioned. PARTITION_HORZ A indicates that a superblock or coding block is partitioned into three coding blocks, where a lower portion is a 2N×N coding block and an upper portion is partitioned into two N×N coding blocks. PARTITION_HORZ_B indicates that a superblock or coding block is partitioned into three coding blocks, where an upper portion is a 2N×N coding block and a lower portion is partitioned into two N×N coding blocks. PARTITION_VERT_A indicates that a superblock or coding block is partitioned into three coding blocks, where a right portion is a 2N×N coding block and a left portion is partitioned into two N×N coding blocks. PARTITION_VERT B indicates that a superblock or coding block is partitioned into three coding blocks, where a left portion is a 2N×N coding block and a right portion is partitioned into two N×N coding blocks. PARTITION_HORZ_4 indicates that a superblock or coding block is partitioned into four coding blocks in the horizontal direction. PARTITION_VERT_4 indicates that a superblock or coding block is partitioned into four coding blocks in the vertical direction. For example, a coding block may be recursively partitioned when partitioned according to a specific partitioning structure. For example, when a coding block is partitioned according to PARTITION_SPLIT, whether to further partition the cording unit recursively may be determined. For example, when the size of a coding block is smaller than a specific size, recursive partitioning may not be allowed regardless of whether the coding unit has been partitioned based on PARTITION_SPLIT. For example, recursive partitioning may not be allowed when the size of a coding block is smaller than 8×8.

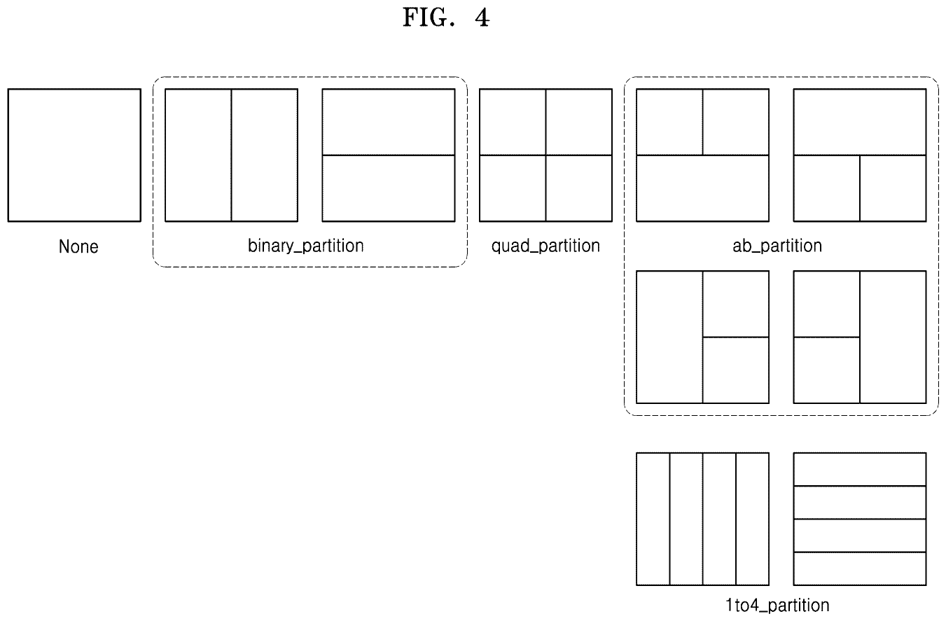

FIG. 4 illustrates an example of a partitioning structure according to an embodiment of the disclosure.

Referring to FIG. 4, a coding block (including a superblock) may not be partitioned, or may be partitioned based on binary partition, quad partition, ab partition, or 1-to-4 partition. A coding block that is not partitioned may be represented as PARTITION_NONE. When the coding block is not partitioned, the block size may be expressed as 2N×2N. A coding block that is partitioned based on binary partition may be represented as PARTITION_HORZ or PARTITION_VERT. A coding block that is partitioned based on quad partition may be represented as PARTITION_SPLIT. A coding block that is partitioned based on ab partition may be represented as PARTITION_HORZ A, PARTITION_HORZ B, PARTITION_VERT A, or PARTITION_VERT_B. A coding block that is partitioned based on 1-to-4 partition may be represented as PARTITION_HORZ_4 or PARTITION_VERT_4.

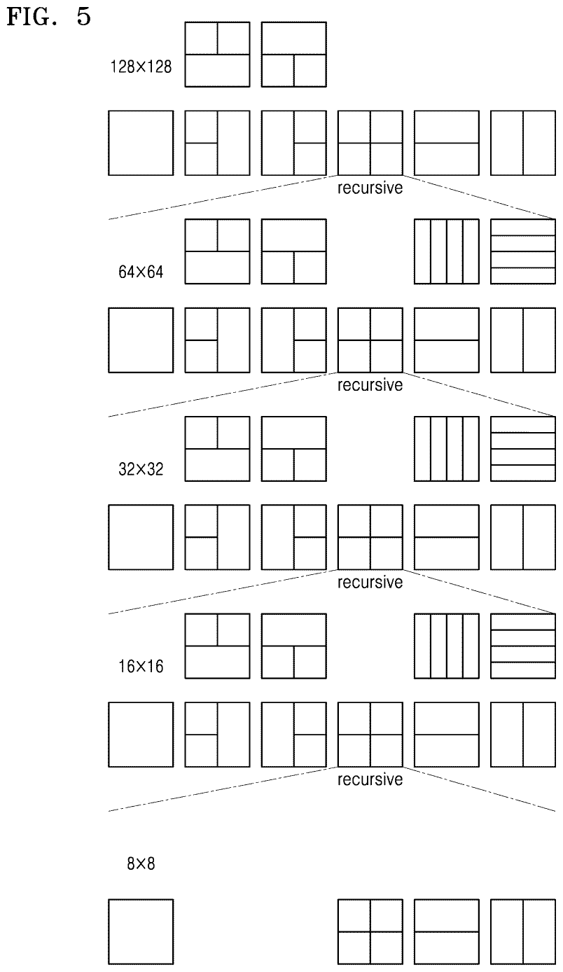

FIG. 5 illustrates an example of a partitioning structure considering recursive partitioning according to an embodiment of the disclosure.

Referring to FIG. 5, a superblock or coding block may be partitioned based on various partitioning structures. When a superblock is quad-tree partitioned, it may be checked whether to further recursively partition the partitioned coding blocks. When a partitioned coding block has a specific size (e.g., when the width and/or height are 9), the partitioned coding block may have limited partitioning candidates. In this case, for example, PARTITION_SPLIT, PARTITION_HORZ, and PARTITION_VERT may be used as candidates.

For example, different partitioning candidates may be used based on a block size. A coding block (including a superblock) with a first size may have first partitioning candidates. A coding block with a second size may have second partitioning candidates. A coding block with a third size may have third partitioning candidates. The first size may be greater than the second size, and the second size may be greater than the third size. Further, the number of second partitioning candidates, which is b, may be greater than the number of first partitioning candidates, which is a, and the number of third partitioning candidates, which is c, may be smaller than the number of second partitioning candidates, which is b. In this case, for example, a may be greater than c. Alternatively, for example, a may be smaller than c. For example, the first partitioning candidates may be a subset of the second partitioning candidates. The third partitioning candidates may be a subset of the second partitioning candidates.

The following table illustrates a relationship between coding block sizes and partitioning candidates.

TABLE 2

| Coding block size | Partitioning candidates |
|---|---|
| First size | First partitioning candidates (e.g., PARTITION_NONE, |
| (e.g., 128 × 128 | PARTITION_HORZ, PARTITION_VERT, PARTITION_SPLIT, |
| or 256 × 256) | PARTITION_HORZ_A, PARTITION_HORZ_B, |
| | PARTITION_VERT_A, PARTITION_VERT_B) |
| Second size | Second partitioning candidates (e.g., PARTITION_NONE, |
| (e.g., 64 × 64 | PARTITION_HORZ, PARTITION_VERT, PARTITION_SPLIT, |
| to 16 × 16) | PARTITION_HORZ_A, PARTITION_HORZ_B, |
| | PARTITION_VERT_A, PARTITION_VERT_B, |
| | PARTITION_HORZ_4, PARTITION_VERT_4) |
| Third size | Third partitioning candidates (e.g., PARTITION_NONE, |
| (e.g., 8 × 8) | PARTITION_HORZ, PARTITION_VERT, PARTITION_SPLIT) |

The partitioning structures described above may be indicated based on partition information. The partition information may indicate one of the partitioning candidates, based on the block size. For example, the partition information may be signaled when the size of the current block is not smaller than 8×8.

The current coding block that has been completely partitioned may be partitioned into transform blocks. Intra prediction may be performed on a transform block basis. A transform block may be a square block or a non-square block. For example, an intra/inter mode and an intra prediction mode may be signaled on a coding block basis, and intra prediction using a neighboring reference sample may be performed per transform block within the coding block.

For example, when the current coding block is an intra block, partitioning information for the transform block may be indicated based on the size, shape, and/or depth information (transform depth information) of the current coding block. For example, when the current coding block is an intra block and a square block, the coding block may be quad-partitioned if the depth information is greater than 0. For example, when the current coding block is an intra block and a non-square block, the coding block may be binary-partitioned if the depth information is greater than 0.

For the partitioning structure, the following partitioning structures may be used in addition to the aforementioned candidates or in place of some of the aforementioned candidates to improve image/video coding efficiency.

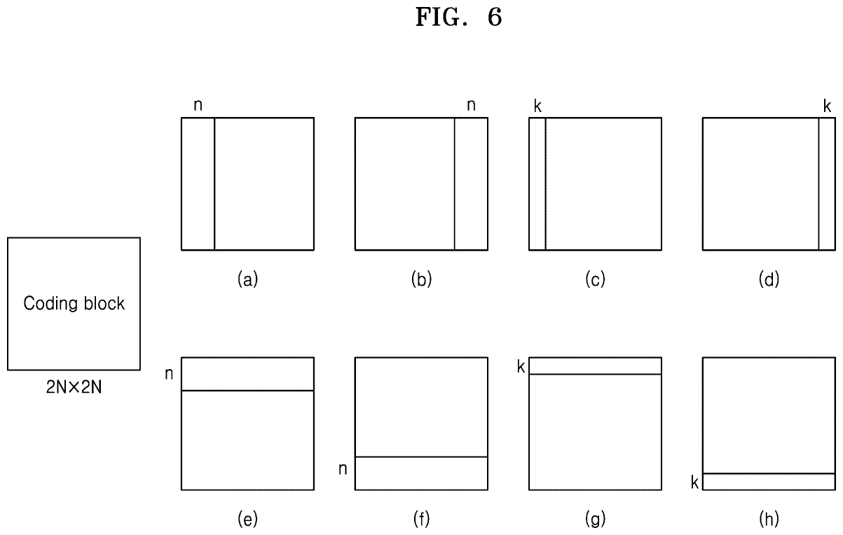

FIG. 6 illustrates examples of partitioning candidates proposed in the disclosure.

Referring to FIG. 6, a coding block may be asymmetrically binary-partitioned into two sub-coding blocks. The two sub-coding blocks may be non-square, and may have different sizes. (a), (b), (c), and (d) of FIG. 6 illustrate examples of vertical partitioning, and (e), (f), (g), and (h) of 1 illustrate examples of horizontal partitioning.

Referring to (a) of FIG. 6, when the size of the coding block is 2N×2N, the size of a first partition (first sub-coding block) is n×2N, and the size of a second partition (second sub-coding block) is (2N−n)×2N. For example, n may be less than or equal to than N/2.

Referring to (b) of FIG. 6, when the size of the coding block is 2N×2N, the size of a first partition (first sub-coding block) is (2N−n)×2N, and the size of a second partition (second sub-coding block) is n×2N. For example, n may be less than or equal to N/2.

Referring to (c) of FIG. 6, when the size of the coding block is 2N×2N, the size of a first partition (first sub-coding block) is k×2N, and the size of a second partition (second sub-coding block) is (2N−k)×2N. For example, k may be less than or equal to N/4.

Referring to (d) of FIG. 6, when the size of the coding block is 2N×2N, the size of a first partition (first sub-coding block) is (2N−k)×2N, and the size of a second partition (second sub-coding block) is k×2N. For example, k may be less than or equal to N/4.

Referring to (e) of FIG. 6, when the size of the coding block is 2N×2N, the size of a first partition (first sub-coding block) is 2N×n, and the size of a second partition (second sub-coding block) is 2N×(2N−n). For example, n may be less than or equal to N/2.

Referring to (f) of FIG. 6, when the size of the coding block is 2N×2N, the size of a first partition (first sub-coding block) is 2N×(2N−n), and the size of a second partition (second sub-coding block) is 2N×n. For example, n may be less than or equal to N/2.

Referring to (g) of FIG. 6, when the size of the coding block is 2N×2N, the size of a first partition (first sub-coding block) is 2N×k, and the size of a second partition (second sub-coding block) is 2N×(2N−k). For example, k may be less than or equal to N/4.

Referring to (h) of FIG. 6, when the size of the coding block is 2N×2N, the size of a first partition (first sub-coding block) is 2N×(2N−k), and the size of a second partition (second sub-coding block) is 2N×k. For example, k may be less than or equal to N/4.

A partitioning structure illustrated in (a) of FIG. 6 may be referred to as a vertical A partition, a partitioning structure illustrated in (b) may be referred to as a vertical B partition, a partitioning structure illustrated in (c) may be referred to as a vertical a partition, a partitioning structure illustrated in (d) may be referred to as a vertical b partition, a partitioning structure illustrated in (e) may be referred to as a horizontal A partition, a partitioning structure illustrated in (f) may be referred to as a horizontal B partition, a partitioning structure illustrated in (g) may be referred to as a horizontal a partition, and a partitioning structure illustrated in (h) may be referred to as a horizontal b partition. However, these structures are examples, and may be referred to by other names. The partitioning structures described above may provide high coding efficiency in certain image characteristics, such as in a case where an object is located near an edge of a block.

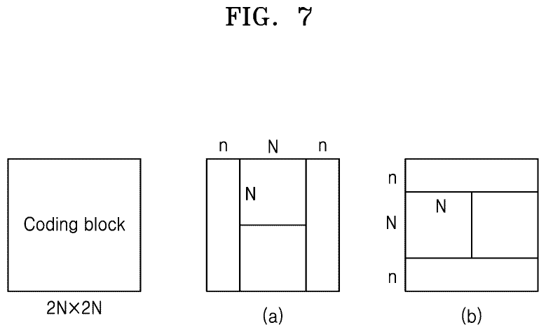

FIG. 7 illustrates examples of partitioning candidates proposed in the disclosure.

Referring to FIG. 7, a coding block may be partitioned into four sub-coding blocks. The four sub-coding blocks may include two square blocks and two non-square blocks. For example, when the size of the coding block is 2N×2N, the size of the two square blocks may be N×N, and the size of the two non-square blocks may be n×2N. For example, when the size of the coding block is 2N×2N, the size of the two square blocks may be N×N, and the size of the two non-square blocks may be 2N×n.

A partitioning structure illustrated in (a) of FIG. 7 may be referred to as a vertical H-type (shaped) partition, and a partitioning structure illustrated in (b) may be referred to as a horizontal H-type (shaped) partition. However, these structures are examples, and may be referred to by other names. The partitioning structures described above may provide high coding efficiency in certain image characteristics, such as in a case where an object is located in a central area of a block.

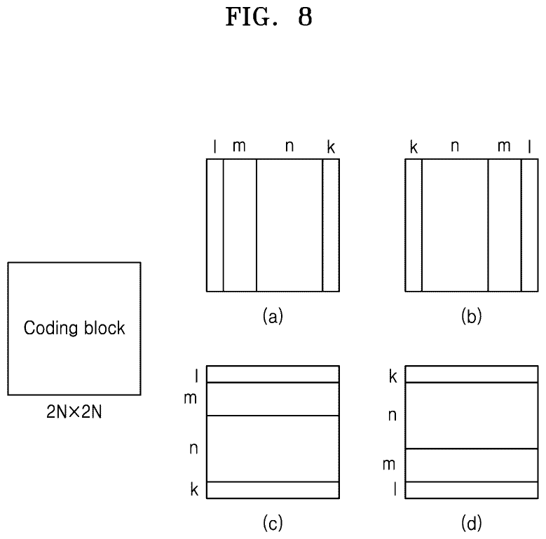

FIG. 8 illustrates examples of partitioning candidates proposed in the disclosure.

Referring to FIG. 8, coding block may be partitioned into four sub-coding blocks, which may be referred to as vertical/horizontal asymmetric quad-partitioning. In this case, the four sub-coding blocks may include four non-square blocks. At least two or three of the four non-square blocks may have different sizes. (a) and (b) of FIG. 8 illustrate examples of vertical partitioning, while (c) and (d) of FIG. 8 illustrate examples of horizontal partitioning.

Referring to (a) of FIG. 8, when the size of the coding block is 2N×2N, the size of a first partition (first sub-coding block) may be 1×2N, the size of a second partition (second sub-coding block) may be m×2N, the size of a third partition (third sub-coding block) may be n×2N, and the size of a fourth partition (fourth sub-coding block) may be k×2N. Here, m may be greater than 1, n may be greater than m, and k may not be greater than n. For example, m may be twice 1, and n may be twice m. Alternatively, n may be equal to m+1 or 2m+1. k may be equal to 1.

Referring to (b) of FIG. 8, when the size of the coding block is 2N×2N, the size of a first partition (first sub-coding block) may be k×2N, the size of a second partition (second sub-coding block) may be n×2N, the size of a third partition (third sub-coding block) may be m×2N, and the size of a fourth partition (fourth sub-coding block) may be 1×2N. Here, m may be greater than 1, n may be greater than m, and k may not be greater than n. For example, m may be twice 1, and n may be twice m. Alternatively, n may be equal to m+1 or 2m+1. k may be equal to 1.

Referring to (c) of FIG. 8, when the size of the coding block is 2N×2N, the size of a first partition (first sub-coding block) may be 2N×1, the size of a second partition (second sub-coding block) may be 2N×m, the size of a third partition (third sub-coding block) may be 2N×n, and the size of a fourth partition (fourth sub-coding block) may be 2N×k. Here, m may be greater than 1, n may be greater than m, and k may not be greater than n. For example, m may be twice 1, and n may be twice m. Alternatively, n may be equal to m+1 or 2m+1. k may be equal to 1.

Referring to (d) of FIG. 8, when the size of the coding block is 2N×2N, the size of a first partition (first sub-coding block) may be 2N×k, the size of a second partition (second sub-coding block) may be 2N×n, the size of a third partition (third sub-coding block) may be 2N×m, and the size of a fourth partition (fourth sub-coding block) may be 2N×1. Here, m may be greater than 1, n may be greater than m, and k may not be greater than n. For example, m may be twice 1, and n may be twice m. Alternatively, n may be equal to m+1 or 2m+1. k may be equal to 1.

A partitioning structure illustrated in (a) of FIG. 8 may be referred to as a vertical 4A partition, a partitioning structure illustrated in (b) may be referred to as a vertical 4B partition, a partitioning structure illustrated in (c) may be referred to as a horizontal 4A partition, and a partitioning structure illustrated in (d) may be referred to as a horizontal 4B partition. However, these structures are examples, and may be referred to by other names. The partitioning structures described above may provide high coding efficiency in certain image characteristics, such as in a case where there is a gradually changing image characteristic.

Although the embodiments disclosed in FIG. 6 to FIG. 8 have been described based on that a coding block to be partitioned being a square block, which is merely for illustration, the same partitioning ratios may be applied to non-square coding blocks.

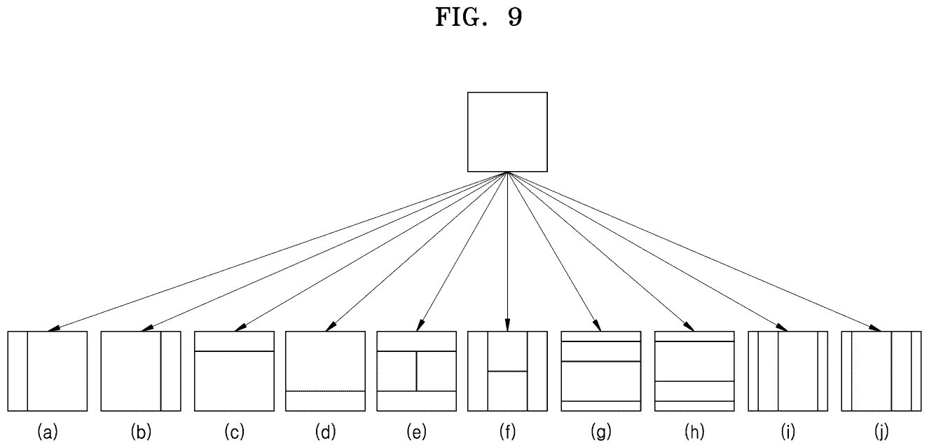

FIG. 9 illustrates an example of a partitioning structure according to another embodiment of the disclosure.

Referring to FIG. 9, in addition to the aforementioned partitioning structures or in place of some candidates, H-type partitioning, and/or asymmetric 1-to-4 partitioning may be included.

For example, (a) to (d) of FIG. 9 illustrate examples of asymmetric binary partitioning of a coding block, (e) and (h) of FIG. 9 illustrate examples of H-type partitioning of the coding block, and (g) to (j) of FIG. 9 illustrate examples of asymmetric 1-to-4 partitioning of the coding block.

For example, the aforementioned partitioning structures may be allowed based on a block size. For example, when the size of the coding block is less than 128×128, asymmetric binary partitioning, H-type partitioning, and/or asymmetric 1-to-4 partitioning illustrated above may be allowed.

However, even when the size of the coding block is smaller than 128×128, the aforementioned partitioning structures may be restricted by comparing the block width and height. For example, when the width-to-height ratio of the coding block is not 1:1 or 1:2 (or 2:1), asymmetric binary partitioning, H-type partitioning, and/or asymmetric 1-to-4 partitioning may not be allowed.

The partitioning structures may be restricted based on the size of a sub-coding block after partitioning. When the width of the sub-coding block after partitioning is greater than 64 and the height is smaller than 64 or when min (width, height) is smaller than 4 or 8, asymmetric binary partitioning, H-type partitioning, and/or asymmetric 1 to 4 partitioning illustrated above may not be allowed for the current coding block.

The coding block may be efficiently partitioned considering various image characteristics, based on the partitioning structures, and procedures such as prediction and transform may be performed based on an optimal block size.

In the examples illustrated above, recursive partitioning may be allowed except when the coding block is not partitioned (PARTITION_NONE). However, even in this case, recursive partitioning may be restricted when the width-to-height ratio of the sub-coding block after partitioning is equal to or exceeds a specific ratio. For example, when the width-to-height ratio of the sub-coding block after partitioning is equal to or exceeds 1:4 (or 4:1) (e.g., 1:8 or 8:1), recursive partitioning may not be allowed.

For example, different partitioning candidates may be used based on a block size. A coding block (including a superblock) with a first size may have first partitioning candidates. A coding block with a second size may have second partitioning candidates. A coding block with a third size may have third partitioning candidates. The first size may be greater than the second size, and the second size may be greater than the third size. Further, the number of second partitioning candidates, which is b, may be greater than the number of first partitioning candidates, which is a, and the number of third partitioning candidates, which is c, may be smaller than the number of second partitioning candidates, which is b. In this case, for example, a may be greater than c. Alternatively, for example, a may be smaller than c. For example, the first partitioning candidates may be a subset of the second partitioning candidates. The third partitioning candidates may be a subset of the second partitioning candidates. For example, the first partitioning candidates may not be a subset of the second partitioning candidates. That is, at least one of the first partitioning candidates may not belong to the second partitioning candidates. The third partitioning candidates may be a subset of the second partitioning candidates.

The following table illustrates a relationship between coding block sizes and partitioning candidates.

TABLE 3

| Coding block size | Partitioning candidates |
|---|---|
| First size | First partitioning candidates (e.g., PARTITION_NONE, |
| (e.g., 128 × 128, | PARTITION_HORZ, PARTITION_VERT, |
| 128 × 256, 256 × 128, | PARTITION_SPLIT) |
| or 256 × 256) | |
| Second size | Second partitioning candidates (e.g., PARTITION_NONE, |
| (e.g., 64 × 256, | PARTITION_HORZ, PARTITION_VERT, asymmetric |
| 256 × 64, 64 × 128, 128 × | binary partitioning candidates, H-type partitioning candidates, |
| 64 , or 64 × 64) | and/or asymmetric 1-to-4 partitioning candidates) |
| Third size | Third partitioning candidates (e.g., PARTITION_NONE, |
| (e.g., 32 × 64, 64 × 32, | PARTITION_HORZ, PARTITION_VERT) |
| 16 × 64, 64 × 16, 8 × 64, | |
| 65 × 8, or 8 × 8) | |

The partitioning structures described above may be indicated based on partition information. The partition information may indicate one of the partitioning candidates, based on the block size. For example, the partition information may be signaled when the size of the current block is not smaller than 8×8. For example, when the size of the current block is smaller than 8×8, PARTITION_NONE may be implicitly indicated.

The partition information may directly indicate one of the partitioning candidates described above based on the block size, or may separately indicate partition type information and partition direction information.

For example, the partition type information and the partition direction information may be sequentially signaled based on a condition as follows.

```
TABLE 4
...
  partition_type
  if(partition_type = !PARTITION_NONE && !PARTITOIN_SPLIT)
    partition_direction
...
```

For example, partition_type may indicate at least one of no partitioning (PARTITION_NONE), quad partitioning (PARTITION_SPLIT), (symmetric) binary partitioning, asymmetric binary partitioning A, asymmetric binary partitioning B, asymmetric binary partitioning a, asymmetric binary partitioning b, H-type partitioning, asymmetric 1-to-4 partitioning A, and/or asymmetric 1-to-4 partitioning B.

partition_direction indicates whether a partitioning direction is vertical or horizontal. partition_direction may be signaled when partition_type does not indicate no partitioning (PARTITION_NONE) and quad partitioning (PARTITION_SPLIT).

In another example, partition_type may indicate at least one of no partitioning (PARTITION_NONE), quad partitioning (PARTITION_SPLIT), (symmetric) binary partitioning, asymmetric binary partitioning, H-type partitioning, and/or asymmetric 1-to-4 partitioning. The following table illustrates an example of partition type indexing.

TABLE 5

| partition_type | description |
|---|---|
| 0 | PARTITION_NONE |
| 1 | PARTITION_SPLIT |
| 2 | (symmetric) binary partition |
| 3 | unsymmetric binary partition |
| 4 | H type partition |
| 5 | unsymmetric 1to4 partition |

partition_direction indicates whether the partitioning direction is vertical or horizontal and mode (A, B, a, or b). The following table illustrates an example of partition direction indexing.

TABLE 6

| partition_direction | description |
|---|---|
| 0 | Vertical (or Vertical A) |
| 1 | Horizontal (or Horizontal A) |
| 2 | Vertical B |
| 3 | Horizontal B |
| 4 | Vertical a |
| 5 | Horizontal a |
| 6 | Vertical b |
| 7 | Horizontal b |

partition_direction 0 may indicate vertical or vertical A depending on the partition type. For example, when the partition type is (symmetric) binary partitioning, partition_direction 0 may indicate vertical partitioning, and when the partition type is an asymmetric type (e.g., asymmetric binary partitioning), partition_direction 0 may indicate vertical A partitioning. For example, when the partition type is (symmetric) binary partitioning, partition_direction 1 may indicate horizontal partitioning, and the partition type is an asymmetric type (e.g., asymmetric binary partitioning), partition_direction 1 camayn indicate horizontal A partitioning. As described above, partition_direction may be signaled when partition_type does not indicate no partitioning (PARTITION_NONE) or quad partitioning (PARTITION_SPLIT).

Meanwhile, as described above, the current coding block that has been completely partitioned may be partitioned into transform blocks. Intra prediction may be performed on a transform block basis. A transform block may be a square block or a non-square block. For example, an intra/inter mode and an intra prediction mode may be signaled on a coding block basis, and intra prediction using a neighboring reference sample may be performed per transform block within the coding block.

When the size of the current coding block that has been completely partitioned is greater than a specific size, implicit transform block partitioning may be performed up to the specific size without separate signaling. Information for additional transform block partitioning may be signaled for a transform block derived up to the specific size.

For example, when the size of the current coding block is 128×256 and the specific size is 128×128, two 128×128 transform blocks may be implicitly derived within the current coding block, and transform block partitioning information (e.g., transform depth information) for each of the 128×128 transform blocks may be separately signaled.

For example, when the size of the current coding block is 256×256 and the specific size is 128×128, four 128×128 transform blocks may be implicitly derived within the current coding block, and transform block partitioning information (e.g., transform depth information) for each of the 128×128 transform blocks may be separately signaled.

For example, when the size of the current coding block is 128×64 and the specific size is 64×64, two 64×64 transform blocks may be implicitly derived within the current coding block, and transform block partitioning information (e.g., transform depth information) for each of the 64×64 transform blocks may be separately signaled.

For example, when the size of the current coding block is 128×128 and the specific size is 64×64, four 64×64 transform blocks may be implicitly derived within the current coding block, and transform block partitioning information (e.g., transform depth information) for each of the 64×64 transform blocks may be separately signaled.

For example, when the size of the current coding block is 128×256 and the specific size is 64×64, eight 64×64 transform blocks may be implicitly derived within the current coding block, and transform block partitioning information (e.g., transform depth information) for each of the 64×64 transform blocks may be separately signaled.

For example, when the size of the current coding block is 256×256 and the specific size is 64×64, 16 64×64 transform blocks may be implicitly derived within the current coding block, and transform block partitioning information (e.g., transform depth information) for each of the 64×64 transform blocks may be separately signaled.

Meanwhile, considering video characteristics, availability information regarding an allowed partitioning type/structure may be signaled through high-level syntax (e.g., a sequence header or frame header). For example, at least one of the asymmetric binary partitioning candidates, the H-type partitioning candidates, and/or the asymmetric 1-to-4 partitioning candidates may be disallowed through the availability information. In this case, the partition information may indicate one of the remaining candidates excluding the disallowed candidates. Indexing for the disallowed candidates may be excluded, and indexing of the remaining candidates may be updated. The same applies to other examples below.

Further, an allowable partitioning type/structure may be configured differently based on the coding block size. For example, when the width of the current coding block is greater than the height thereof, at least one of partitioning candidates with horizontal orientation among the aforementioned candidates may be disallowed. For example, when the width of the current coding block is smaller than the height thereof, at least one of partitioning candidates with vertical orientation among the aforementioned candidates may be disallowed. In this case, the partition information may indicate one of the remaining candidates excluding the disallowed candidates.

Meanwhile, for a coding block that contacts or extends across a frame boundary, it may be determined whether the boundary is a right boundary or a bottom boundary of the frame, and (symmetric/asymmetric) horizontal or vertical partitioning may be implicitly derived without partition information signaling.

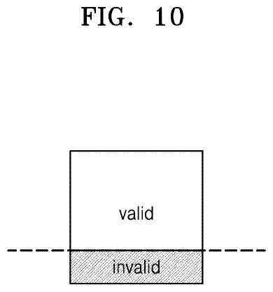

FIG. 10 illustrates an example in which a coding block is located across a frame boundary.

Referring to FIG. 10, the resolution of a frame may not match a block partitioning ratio, and a specific coding block may be located across a frame boundary, considering the size thereof based on an original partitioning structure. In this case, it is unnecessary to signal partition information by considering all partitioning candidates.

For example, when the coding block touches or is located across a right boundary of the frame, quad partitioning or (symmetric/asymmetric) vertical partitioning may be derived for the coding block without signaling partition information. For example, when the coding block touches or is located across a bottom boundary of the frame, quad partitioning or (symmetric/asymmetric) horizontal partitioning may be derived for the coding block without signaling partition information. For example, when the coding block touches or is located across the right and bottom boundaries of the frame, quad partitioning may be derived for the coding block without signaling partition information.

In this case, the partitioning structure may be derived in further consideration of the size of the coding block without signaling partition information. For example, when the coding block touches or is located across the right boundary of the frame, quad partitioning may be implicitly derived if the coding block is a square block, and (symmetric/asymmetric) vertical partitioning maybe implicitly derived if the coding block is a non-square block. For example, when the coding block touches or is located across the bottom boundary of the frame, quad partitioning may be implicitly derived if the coding block is a square block, and (symmetric/asymmetric) horizontal partitioning maybe implicitly derived if the coding block is a non-square block.

For example, one of the above-described symmetric/asymmetric vertical (binary) partitions may be implicitly derived based on a position of a right boundary of the frame is located within the coding block.

For example, when the right boundary of the frame is located within a first range of the coding block, (symmetric) vertical (binary) partitioning may be implicitly derived for the coding block. When the right boundary of the frame is located within a second range of the coding block, vertical A partitioning may be implicitly derived for the coding block. When the right boundary of the frame is located in a third range of the coding block, vertical B partitioning may be implicitly derived for the coding block. In this case, for example, the first range may be greater than or equal to W/2 and less than 3W/4 of the coding block, based on the x-coordinate. For example, the second range may be less than W/2 of the coding block, based on the x-coordinate. For example, the third range may be greater than or equal to 3W/4 (and less than W) of the coding block, based on the x-coordinate. Here, W may denote the width of the coding block. W may be equal to 2N.

For example, when the right boundary of the frame is located within a first range of the coding block, (symmetric) vertical (binary) partitioning may be implicitly derived for the coding block. When the right boundary of the frame is located within a second range of the coding block, vertical A partitioning may be implicitly derived for the coding block. When the right boundary of the frame is located in a third range of the coding block, vertical B partitioning may be implicitly derived for the coding block. When the right boundary of the frame is located in a fourth range of the coding block, vertical a partitioning may be implicitly derived for the coding block. When the right boundary of the frame is located in a fifth range of the coding block, vertical b partitioning may be implicitly derived for the coding block. In this case, for example, the first range may be greater than or equal to W/2 and less than 3W/4 of the coding block in terms of the x-coordinate. For example, the second range may be greater than or equal to W/4 and less than W/2 of the coding block, based on the x-coordinate. For example, the third range may be greater than or equal to 3W/4 and less than 7W/8 of the coding block, based on the x-coordinate. For example, the fourth range may be less than W/4 of the coding block, based on the x-coordinate. For example, the fifth range may be greater than or equal to 7W/8 (and less than W) of the coding block, based on the x-coordinate. Here, W may denote the width of the coding block. W may be equal to 2N.

As another example, one of the above-described symmetric or asymmetric horizontal (binary) partitions may be implicitly derived based on a position of a bottom boundary of the frame within the coding block.

For example, when the bottom boundary of the frame is located within a first range of the coding block, (symmetric) horizontal (binary) partitioning may be implicitly derived for the coding block. When the bottom boundary of the frame is located within a second range of the coding block, horizontal A partitioning may be implicitly derived for the coding block. When the bottom boundary of the frame is located in a third range of the coding block, horizontal B partitioning may be implicitly derived for the coding block. In this case, for example, the first range may be greater than or equal to W/2 and less than 3W/4 of the coding block, based on the x-coordinate (horizontal). For example, the second range may be less than W/2 of the coding block, based on the x-coordinate. For example, the third range may be greater than or equal to 3W/4 (and less than W) of the coding block, based on the x-coordinate. Here, W may denote the width of the coding block. W may be equal to 2N.

For example, when the bottom boundary of the frame is located within a first range of the coding block, (symmetric) horizontal (binary) partitioning may be implicitly derived for the coding block. When the bottom boundary of the frame is located within a second range of the coding block, horizontal A partitioning may be implicitly derived for the coding block. When the bottom boundary of the frame is located in a third range of the coding block, horizontal B partitioning may be implicitly derived for the coding block. When the bottom boundary of the frame is located in a fourth range of the coding block, horizontal a partitioning may be implicitly derived for the coding block. When the bottom boundary of the frame is located in a fifth range of the coding block, horizontal b partitioning may be implicitly derived for the coding block. In this case, for example, the first range may be greater than or equal to H/2 and less than 3H/4 of the coding block in terms of the y-coordinate (vertical). For example, the second range may be greater than or equal to H/4 and less than H/2 of the coding block, based on the y-coordinate. For example, the third range may be greater than or equal to 3H/4 and less than 7H/8 of the coding block, based on the y-coordinate. For example, the fourth range may be less than H/4 of the coding block, based on the y-coordinate. For example, the fifth range may be greater than or equal to 7H/8 (and less than H) of the coding block, based on the y-coordinate. Here, H may denote the height of the coding block. H may be equal to 2N.

Through the partitioning structures described above, a block partitioning structure that minimizes invalid areas to be processed may be efficiently derived while minimizing explicit signaling.

To restrict redundant partitioning, a partitioning structure that is derivable directly from an upper coding block may be excluded from candidates when signaling partitioning information for a lower coding block.

A luma component block and a chroma component block may have the same partitioning structure. Alternatively, a luma component block and a chroma component block may have semi-independent partitioning structures. For example, when the size of a coding block for a luma component is within a first range (e.g., up to 128×128), the same luma/chroma partitioning structure may be applied, and when the size is within a second range smaller than the first range, an independent luma/chroma partitioning structure may be applied. The same partitioning structure may be applied to chroma component blocks (U and V blocks).

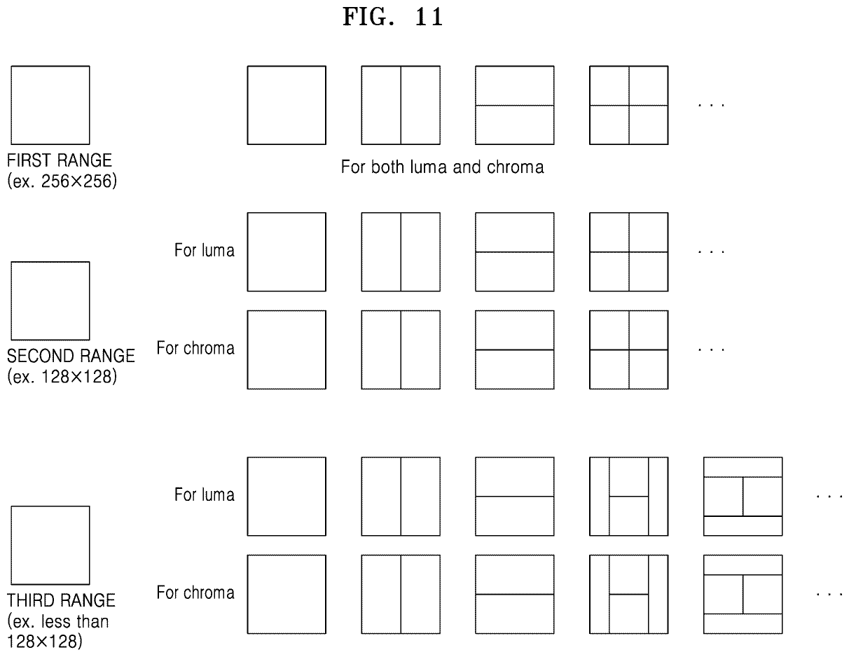

FIG. 11 illustrates an example of signaling a semi-independent partitioning structure.

Referring to FIG. 11, the same partitioning structure may be applied to a luma component block and a chroma component block when the size of a coding block for a luma component is within a first range. In this case, a partitioning structure for the luma component block and the chroma component block may be derived based on single partition information. When the size of the coding block for the luma component falls within a second range or less, an independent luma/chroma partitioning structure may be applied. In this case, luma partition information and chroma partition information may be signaled separately, and may have different values. When the size of the coding block for the luma component falls within a third range, available partitioning candidates may be changed. This hierarchical semi-independent partitioning structure signaling enables efficient signaling of an optimal coding block size.

Whether to use the aforementioned semi-independent partitioning structures may be determined in further consideration of a frame type. Frame type information may be signaled in a frame header or a tile header.

Various frame types may be used for efficient compression and random access. Each frame type may be classified by a reference method and a compression method. The following table illustrates examples of frame types.

TABLE 7

| frame_type | Description |
|---|---|
| 0 | KEY_FRAME |
| 1 | INTER_FRAME |
| 2 | INTRA_ONLY_FRAME |
| 3 | SWITCH_FRAME |

A key frame (KEY_FRAME) may represent a frame used when a new sequence of an image begins. The key frame may be coded independently without a previous frame (reference frame). An inter frame (INTER_FRAME) may represent a frame that is coded by prediction based on a previous frame (reference frame). In the inter frame, inter prediction and intra prediction may be used. An intra-only frame (INTRA_ONLY_FRAME) is similar to the key frame, but may represents a frame that performs only intra coding while maintaining an existing reference frame. A switch frame (SWITCH_FRAME) is similar to the intra-only frame, but may represents a frame designed to enable random access. The switch frame may start a new sequence while maintaining an existing reference frame.

For example, in a case where a frame type is a key frame (KEY_FRAME) or an intra-only frame (INTRA_ONLY_FRAME), as described above, the same luma/chroma partitioning structure may be applied up to the first range (e.g., 128×128) of the size of the coding block for the luma component, while an independent luma/chroma partitioning structure may be applied for the second range, which is smaller than the first range. When the frame type is an inter-frame (INTER_FRAME) or a switch frame (SWITCH_FRAME), the luma component block and the chroma component block may have the same partitioning structure regardless of the sizes thereof.

For example, from a signaling perspective, in a case where the frame type is a key frame (KEY_FRAME) or an intra-only frame (INTRA_ONLY_FRAME), partition information may be signaled when the size of the coding block (including a superblock) is within the first range, while luma partition information and chroma partition information may be signaled separately when the size of the coding block is in the second range.

Through the aforementioned hierarchical semi-independent partitioning structure signaling that considers a frame type, an optimal coding block size according to frame characteristics may be efficiently signaled.

In intra prediction, prediction samples of a current block are generated using reconstructed samples of a neighboring block within a current frame. The current block may be a coding block or a transform block. For example, an intra prediction mode/type may be derived on a coding block basis, while a process of generating prediction samples based on neighboring reference samples may be performed on a transform block basis. When intra prediction is applied to the current block, neighboring reference samples used for intra prediction of the current block may be derived. The neighboring reference samples for the current block may include H+W samples located to the left of the W×H current block, W+H samples located on the top of the current block, and at least one sample neighboring the top-left of the current block. Alternatively, the neighboring reference samples for the current block may include a plurality of rows of top neighboring samples and a plurality of columns of left neighboring samples. The neighboring reference samples for the current block may include a plurality of rows of top neighboring samples and a plurality of columns of left neighboring samples. When a plurality of transform blocks exists within the coding block, intra prediction (deriving neighboring reference samples and generating prediction samples) may be performed sequentially in raster scan order. For example, an intra prediction procedure may be triggered based on a predict_intra function call.

The intra prediction procedure may be broadly divided into an intra prediction mode/type derivation procedure, a neighboring sample derivation procedure, and an (intra) prediction sample(s) generation procedure. However, some procedures may be omitted depending on an intra prediction mode.

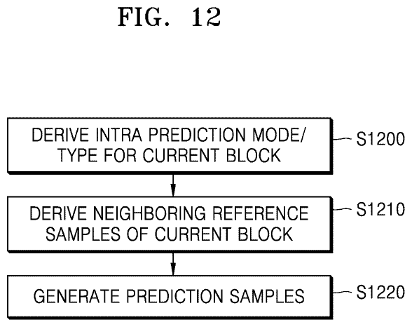

FIG. 12 illustrates an intra prediction procedure.

Referring to FIG. 12, as described above, the procedure may be divided into a prediction mode/type derivation procedure, a neighboring sample derivation procedure, and an (intra) prediction sample(s) generation procedure. As described above, the intra prediction procedure may be performed equally or correspondingly in an encoding apparatus and a decoding apparatus. In the disclosure, a coding apparatus may include an encoding apparatus and/or a decoding apparatus.

The coding apparatus determines an intra prediction mode/type for a current block (S1200). The current block may correspond to a coding block or a transform block.

The encoding apparatus may determine an intra prediction mode/type applied to the current block from among various intra prediction modes/types described in the disclosure, and may generate prediction-related information. The prediction-related information may include intra prediction mode information indicating the intra prediction mode applied to the current block and/or intra prediction type information indicating the intra prediction type applied to the current block. The decoding apparatus may determine an intra prediction mode/type applied to the current block, based on the prediction-related information.

The intra prediction type may indicate various prediction types for performing intra prediction. The intra prediction type may include, for example, multiple reference line selection (MRLS), intra-bi-prediction (IBP), recursive intra-prediction (RIP), and intra-prediction fusion. MRLS may refer to a prediction type that performs intra prediction by selecting some of multiple reference sample lines for intra-prediction. IBP may refer to a prediction type that performs prediction by using a reference sample in a prediction direction and a reference sample in the opposite direction during intra prediction. RIP may refer to a prediction type that partitions a current block into subblocks (or patches) of an m×n sample area (e.g., m is 4 and n is 2) and sequentially generates samples neighboring the corresponding area.

For example, when intra prediction is applied, an intra prediction mode applied to the current block may be determined based on an intra prediction mode of a spatial/temporal neighboring block. For example, the coding apparatus may derive intra prediction modes available for the current block, based on an intra prediction modes of a neighboring block (e.g., left and/or top neighboring blocks) of the current block and/or an intra prediction mode of a temporal neighboring block (e.g., a co-located block in a reference frame). The available intra prediction modes may be prioritized (i.e., ranked) based on the intra prediction mode of the neighboring block (e.g., the left and/or upper neighboring blocks) of the current block and/or the intra prediction mode of the temporal neighboring block (e.g., the co-located block in the reference frame). In this case, the available intra prediction modes may be divided into a plurality of mode sets, based on priorities (or ranks). The encoding apparatus may generate mode set index information and/or mode index information. The mode set index information may indicate a mode set including an intra prediction mode applied to the current block among the plurality of mode sets. The mode index information may indicate an index of the intra prediction mode applied to the current block within the indicated mode set.

The encoding apparatus may perform prediction, based on various intra prediction modes/types, and may determine an optimal intra prediction mode/type, based on rate-distortion optimization (RDO) based thereon. In this case, the encoding apparatus may determine the optimal intra prediction mode using candidates within the mode set. Specifically, for example, when the intra prediction type of the current block is not a normal intra prediction type but a specific type (e.g., MRLS, IBP, or RIP), the encoding apparatus may determine the optimal intra prediction mode by considering only candidates of a first mode set among the mode sets as intra prediction mode candidates for the current block. That is, in this case, the intra prediction mode for the current block may be determined only from the first mode set, in which case the mode set index information may not be explicitly coded/signaled. In this case, the decoding apparatus may consider that the first mode set is selected without explicitly parsing/signaling the mode set index information. The first mode set may correspond to a mode set with a highest priority (rank) indicated when a value of the mode set index information is 0. In this case, the index of the intra prediction mode applied to the current block within the first mode set may be indicated based on signaling of the mode index information without signaling the mode set index. Accordingly, it is possible to reduce complexity and the number of bits required for mode signaling, while improving intra prediction efficiency by using a high-priority intra prediction mode.

The coding apparatus derives neighboring reference samples of the current block (S1210). The neighboring reference samples of the current block may include H+W samples located to the left of the W×H current block, W+H samples located on the top of the current block, and at least one sample neighboring the top-left of the current block. Alternatively, the neighboring reference samples of the current block may include a plurality of rows of top neighboring samples and a plurality of columns of left neighboring samples.

Some of the neighboring reference samples of the current block may not yet have been decoded/reconstructed, or may be unavailable. In this case, the coding apparatus may configure neighboring reference samples used for intra prediction by padding or substituting unavailable samples with available samples.

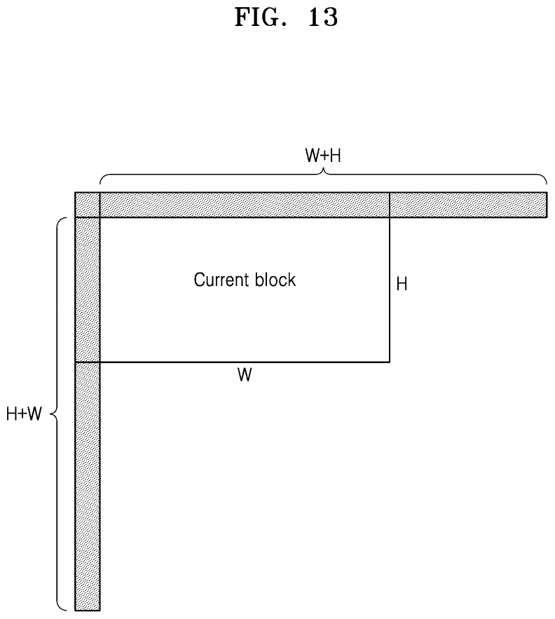

FIG. 13 illustrates examples of neighboring reference samples for intra prediction.

Referring to FIG. 13, neighboring reference samples of the current block may include W+H or more top reference samples, H+W or more left reference samples, and one or more top-left reference samples. The neighboring reference samples may include top neighboring reference samples (A), top-right reference samples (AR), left neighboring reference samples (L), bottom-left reference samples (BL), and a top-left reference sample (AL).

For example, the top reference samples may be represented as AboveRow[i], where i may have a value of 0 to W+H−1. When the top reference samples are unavailable, if the left reference samples are available, one of the left reference samples may be used as a sample value for the top reference samples. Specifically, for example, the unavailable top reference samples may be padded or substituted to be identical to an uppermost reference sample among the left neighboring reference samples. That is, the unavailable top reference samples may be padded or substituted to be identical to a left reference sample at a coordinate (x−1, y). Here, (x, y) may represent the position of the top-left sample of the current block (e.g., a coding block or transform block). When the top reference samples are unavailable and the left reference samples are also unavailable, the top reference samples may be padded or substituted with a default value derived based on a predetermined bit depth. The default value may be set to, for example, (1<<(BitDepth−1))−1. Alternatively, the unavailable top reference samples may be padded or substituted to be identical to the top-left reference sample.

When the top reference samples are available, reconstructed sample values of the top reference samples are basically used as values of the top reference samples. When the top reference samples are available, a first parameter may be determined. The first parameter may be determined as, for example, x+2W−1. When H>W, the reconstructed sample values are not used for specific top reference samples having an x-coordinate greater than the first parameter, and a value of a top reference sample having an x-coordinate of the first parameter is copied (padded or substituted) for the specific top reference samples. That is, for the specific top reference samples, a value of a top reference sample at a coordinate (first parameter, y−1) may be copied (padded or substituted). Alternatively, when H>W, a value of a 2W-th top reference sample may be copied (padded or substituted) for top reference samples after the 2W-th top reference sample.

The left reference samples may be represented, for example, as LeftCol[i], where i may have a value of 0 to W+H−1. When the left samples are unavailable, if the top reference samples are available, one of the top reference samples may be used as a sample value for the left reference samples. Specifically, for example, the unavailable left reference samples may be padded or substituted to be identical to a leftmost reference sample among the top neighboring reference samples. That is, the unavailable left reference samples may be padded or substituted to be identical to a top reference sample at a coordinate (x, y−1). Here, (x, y) may represent the position of the top-left sample of the current block (e.g., a coding block or transform block). When the left reference samples are unavailable and the top reference samples are also unavailable, the left reference samples may be padded or substituted with a default value derived based on a predetermined bit depth. The default value may be set to, for example, (1<<(BitDepth−1))−1. Alternatively, the unavailable left reference samples may be padded or substituted to be identical to the top-left reference sample.

When the left reference samples are available, reconstructed sample values of the left reference samples are basically used as values of the left reference samples. When the left reference samples are available, a second parameter may be determined. The second parameter may be determined as, for example, x+2H−1. When W>H, the reconstructed sample values are not used for specific left reference samples having a y-coordinate greater than the second parameter, and a value of a left reference sample having a y-coordinate of the second parameter is copied (padded or substituted) for the specific left reference samples. That is, for the specific left reference samples, a value of a left reference sample at a coordinate (x−1, second parameter) may be copied (padded or substituted). Alternatively, when W>H, a value of a 2H-th left reference sample may be copied (padded or substituted) for left reference samples after the 2H-th left reference sample.

The top-left reference sample includes a reference sample at a coordinate (x−1, y−1), and may be represented as AboveRow[−1] or LeftCol[−1] for convenience. When the top-left reference sample is available, a reconstructed sample value of the reference sample is used. When the top-left reference sample is unavailable, a value of an available left reference sample at a coordinate (x−1, y) or an available top reference sample at a coordinate (x, y−1) may be copied (padded or substituted). When the top-left reference sample is unavailable and both the left reference sample and top reference sample are unavailable, the top-left reference samples may be padded or substituted with a default value derived based on a given bit depth. The default value may be set to, for example, (1<<(BitDepth−1))−1.

Referring back to FIG. 12, the coding apparatus generates prediction samples of the current block (S1220). The coding apparatus may generate the prediction samples, based on the intra prediction mode/type and the reference samples. The coding apparatus may derive a reference sample according to the intra prediction mode of the current block among the reference samples of the current block, and may derive a prediction sample of the current block, based on the reference sample.

The intra prediction mode may be signaled based on the intra prediction mode information, and the intra prediction type may be signaled based on the intra prediction type information. The intra prediction mode information and/or the intra prediction type information may be encoded/decoded through binarization and coding methods described in the disclosure. For example, the intra prediction mode information and/or the intra prediction type information may be encoded/decoded through various coding methods (e.g., CDF and CABAC).

For example, the intra prediction mode may include the following intra prediction modes.

TABLE 8

| Intra prediction mode number | Classification |
|---|---|
| 0 | DC intra prediction mode |
| 1~8 | Directional intra prediction modes |
| 9~11 | SMOOTH intra prediction modes |
| 12 | PAETH intra prediction mode |

In a DC intra prediction mode, the current block may be predicted using an average value of the neighboring reference samples of the current block. The DC intra prediction mode may be referred to as a DC prediction mode or DC mode. In directional intra prediction modes, prediction may be performed using a value of a reference sample located in a specific direction based on a sample position within the current block. The directional intra prediction modes may basically include a horizontal mode, a horizontal-left-down (D203) mode, a horizontal-left-up (D157) mode, a diagonal-left-up (D135) mode, a vertical mode, a vertical-left-up (D133) mode, a vertical-right-up (D67) mode, and a diagonal-right-up (D45) mode. Further, an angle delta value may be additionally signaled to indicate a more detailed intra prediction direction. In SMOOTH intra prediction modes, prediction may be performed by interpolating values of the neighboring reference samples of the current block. In this case, vertical interpolation, horizontal interpolation, or both vertical interpolation and horizontal interpolation may be performed depending on a mode. In a PAETH intra prediction mode, prediction may be performed using the top-left reference sample, a left reference sample, and a top reference sample of the current block. In this case, prediction may be performed using a difference between the left reference samples and the top-left reference sample and a difference between the top reference sample and the top-left reference sample. A chroma-from-luma (CFL) intra prediction mode for a chroma block may be further considered. In the CFL intra prediction mode, a chroma block may be predicted based on a linear or nonlinear model using a reconstructed luma block. For example, the CFL intra prediction mode may be assigned intra prediction mode number 13.

As described above, a plurality of directional intra prediction modes may be considered to improve intra prediction performance.

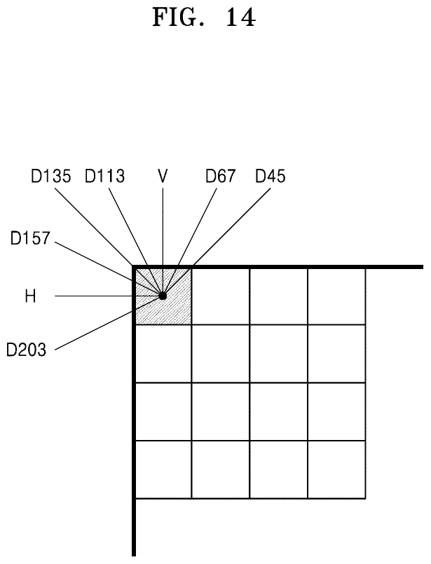

FIG. 14 illustrates directional intra prediction modes described in the disclosure.

Referring to FIG. 14, the directional intra prediction modes may basically include a horizontal mode, a horizontal-left-down (D203) mode, a horizontal-left-up (D157) mode, a diagonal-left-up (D135) mode, a vertical mode, a vertical-left-up (D133) mode, a vertical-right-up (D67) mode, and a diagonal-right-up (D45) mode. Further, an angle delta value may be additionally signaled to indicate a more detailed intra prediction direction. When a directional intra prediction mode is applied, a prediction sample may be generated using a reference sample located in an intra prediction direction relative to the position of a target sample within a current block. However, this example is merely for illustration, and more directional prediction modes may be used.

Further, as described above, an angle delta value may be additionally signaled to indicate a more detailed intra prediction direction.

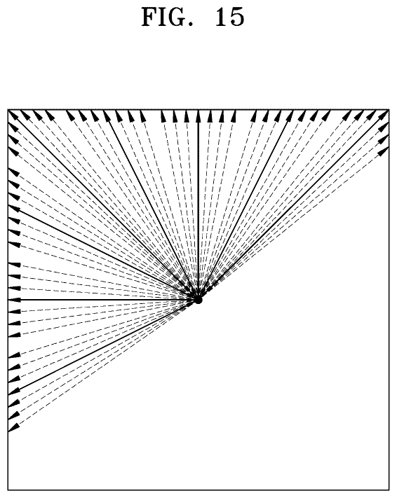

FIG. 15 illustrates directional intra prediction modes extended based on an angle delta value.

Referring to FIG. 15, information indicating one of n angle deltas (or offsets) may be signaled based on the aforementioned basic intra prediction directions, such as the horizontal mode, the horizontal-left-down (D203) mode, the horizontal-left-up (D157) mode, the diagonal-left-up (D135) mode, the vertical mode, the vertical-left-up (D133) mode, the vertical-right-up (D67) mode, and the diagonal-right-up (D45) mode. Here, n is, for example, 6. That is, based on the basic intra prediction directions, three angle delta values may exist on each of the left and right sides in addition to a 0-degree default. In other words, each basic intra prediction direction may have a total of eight detailed intra prediction directions.

For example, information regarding an angle delta may be signaled based on a block size. For example, when an intra prediction mode of a current block is a directional intra prediction mode and the width and/or height of the current block is 8 or greater, information regarding an angle delta may be additionally signaled.

For example, when the intra prediction mode of the current block is a directional intra prediction, an angle delta flag may be signaled first, and angle delta index information may be signaled if a value of the angle delta flag is 1. The angle delta index information may indicate one of the aforementioned angle deltas. When the value of the angle delta flag is 0, signaling of the angle delta index information may be omitted.

As described above, neighboring reference samples for intra prediction may be based on multiple reference line selection (MRLS). In this case, the neighboring reference samples may include a plurality of rows of top neighboring reference samples and a plurality of columns of left neighboring reference samples.

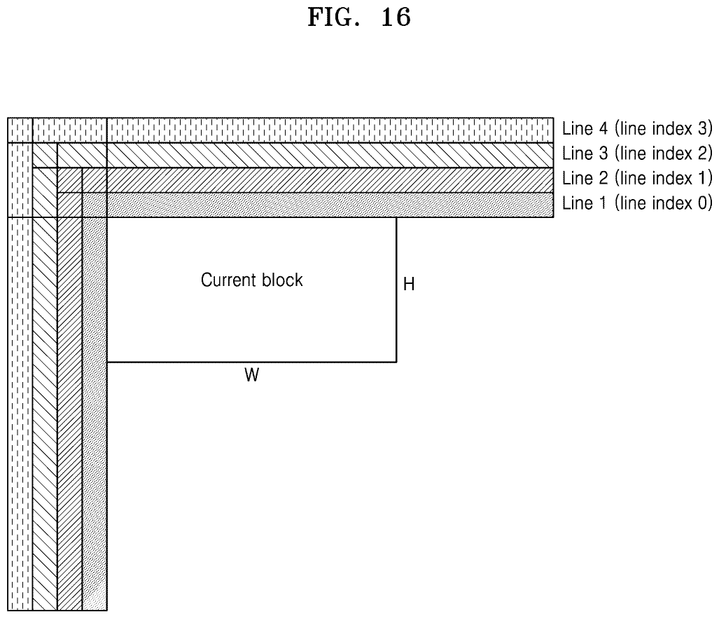

FIG. 16 illustrates an example of multiple reference lines of neighboring reference samples for intra prediction. Although four lines are illustrated herein merely as an example, more or fewer lines may be used.

Referring to FIG. 16, a line of neighboring reference samples for a current block may include W+H or more top reference samples, H+W or more left reference samples, and at least one more top-left reference sample. Here, line 1 (reference sample line 1) indicates a reference sample line adjacent to the current block. Line 2 (reference sample line 2) indicates a reference sample line located at a distance of one sample from a left/top boundary of the current block. Line 3 (reference sample line 3) indicates a reference sample line located at a distance of two samples from the left/top boundary of the current block. Line 4 (reference sample line 4) indicates a reference sample line located at a distance of three samples from the left/top boundary of the current block.

For example, a top-left reference sample area of line 1 may include one top-left reference sample. A top-left reference sample area of line 2 may include three top-left reference samples. A top-left reference sample area of line 3 may include five top-left reference samples. A top-left reference sample area of line 4 may include seven top-left reference samples.

For example, when a reference sample line number increases, the number of top-left reference samples in a top-left reference sample area may increase, while the number of top reference samples in a top reference sample area may not increase. For example, the number of top-left reference samples in line n+1 may be greater than the number of top-left reference samples in line n, and the number of top reference samples in line n may be equal to the number of top reference samples in line n+1. For example, n may be 1, 2, 3, and the like.

For example, when the reference sample line number increases, the number of top-left reference samples in the top-left reference sample area may increase, while the number of left reference samples in a left reference sample area may not increase. For example, the number of top-left reference samples in line n+1 may be greater than the number of top-left reference samples in line n, and the number of left reference samples in line n may be equal to the number of left reference samples in line n+1. For example, n may be 1, 2, 3, and the like.

For example, when an intra prediction direction, based on the position of a specific sample in the current block, points to the right of a rightmost reference sample in a top reference line, a predicted sample value of the specific sample may be set equal to a value of the rightmost reference sample. For example, when the intra prediction direction, based on the position of the specific sample in the current block, points to the bottom of a bottommost reference sample in a left reference line, the predicted sample value of the specific sample may be set equal to a value of the bottommost reference sample. Through this method, even when multiple reference lines are used, a fixed number (e.g., W+H) of top reference samples and left reference samples may be used regardless of a line.

Even when the plurality of reference lines is used, some of the neighboring reference samples may not yet have been decoded/reconstructed or may not be available. In this case, the coding apparatus may configure neighboring reference samples to be used for intra prediction by padding or substituting unavailable samples with available samples. A reference line index may be denoted as rlidx.

For example, the top reference samples in reference sample line n may be represented as AboveRow[i], where i may have a value of 0 to W+H−1. When the top reference samples are unavailable, if the left reference samples are available, one of the left reference samples may be used as a sample value for the top reference samples. Specifically, for example, the unavailable top reference samples may be padded or substituted to be identical to an uppermost reference sample among the left neighboring reference samples. That is, the unavailable top reference samples may be padded or substituted to be identical to a left reference sample at a coordinate (x−1−rlidx, y). Here, (x, y) may represent the position of the top-left sample of the current block (e.g., a coding block or transform block). When the top reference samples are unavailable and the left reference samples are also unavailable, the top reference samples may be padded or substituted with a default value derived based on a predetermined bit depth. The default value may be set to, for example, (1<<(BitDepth−1))−1. Alternatively, the unavailable top reference samples may be padded or substituted to be identical to the top-left reference sample at a coordinate (x−1, y−1−rlidx).

When the top reference samples are available, reconstructed sample values of the top reference samples are basically used as values of the top reference samples. When the top reference samples are available, a first parameter may be determined. The first parameter may be determined as, for example, x+2W−1. When H>W, the reconstructed sample values are not used for specific top reference samples having an x-coordinate greater than the first parameter, and a value of a top reference sample having an x-coordinate of the first parameter is copied (padded or substituted) for the specific top reference samples. That is, for the specific top reference samples, a value of a top reference sample at a coordinate (first parameter, y−1) may be copied (padded or substituted). Alternatively, when H>W, a value of a 2W-th top reference sample may be copied (padded or substituted) for top reference samples after the 2W-th top reference sample.

The left reference samples may be represented, for example, as LeftCol[i], where i may have a value of 0 to W+H−1. When the left samples are unavailable, if the top reference samples are available, one of the top reference samples may be used as a sample value for the left reference samples. Specifically, for example, the unavailable left reference samples may be padded or substituted to be identical to a leftmost reference sample among the top neighboring reference samples. That is, the unavailable left reference samples may be padded or substituted to be identical to a top reference sample at a coordinate (x, y−1−rlidx). Here, (x, y) may represent the position of the top-left sample of the current block (e.g., a coding block or transform block). When the left reference samples are unavailable and the top reference samples are also unavailable, the left reference samples may be padded or substituted with a default value derived based on a predetermined bit depth. The default value may be set to, for example, (1<<(BitDepth−1))−1. Alternatively, the unavailable left reference samples may be padded or substituted to be identical to the top-left reference sample at a coordinate (x−1−rlidx, y−1).

When the left reference samples are available, reconstructed sample values of the left reference samples are basically used as values of the left reference samples. When the left reference samples are available, a second parameter may be determined. The second parameter may be determined as, for example, x+2H−1. When W>H, the reconstructed sample values are not used for specific left reference samples having a y-coordinate greater than the second parameter, and a value of a left reference sample having a y-coordinate of the second parameter is copied (padded or substituted) for the specific left reference samples. That is, for the specific left reference samples, a value of a left reference sample at a coordinate (x−1, second parameter) may be copied (padded or substituted). Alternatively, when W>H, a value of a 2H-th left reference sample may be copied (padded or substituted) for left reference samples after the 2H-th left reference sample.

The top-left reference samples may be represented as AboveRow[−i] and/or LeftCol[−j] for convenience, where i may include 1 to rlidx, and j may include 1 to rlidx−1. When the top-left reference sample is available, a reconstructed sample value of the reference sample is used. When the top-left reference sample is unavailable, a value of an available left reference sample at a coordinate ((x−1−rlidx, y) or an available top reference sample at a coordinate (x, y−1−rlidx) may be copied (padded or substituted). When the top-left reference samples are unavailable and both the left reference sample and top reference sample are unavailable, the top-left reference samples may be padded or substituted with a default value derived based on a given bit depth. The default value may be set to, for example, (1<<(BitDepth−1))−1.

Reference line selection information (or reference line index information) related to the plurality of reference lines may be signaled. The reference line selection information may be signaled on a coding block basis. That is, the reference line selection information may be signaled on a coding block basis, reference samples for transform blocks within the coding block may be derived using the same reference line number, and intra prediction may be sequentially performed. In this case, intra prediction may be performed on the transform blocks in raster scan order.

For example, the plurality of reference lines may be applied only when the current block is a luma component block. That is, the reference line selection information may be signaled when the coding block is a luma component block.

For example, when a prediction type is IBP and/or RIP, the reference line selection information may not be explicitly signaled. When the reference line selection information is not explicitly signaled, a value of the reference line selection information may indicate 0, which may indicate line number 1.

For example, the reference line selection information may be signaled after intra prediction mode information is signaled.

TABLE 9

```
...
  intra_pred_mode
  if(is_directional_mode)
    reference_line
...
```

Here, intra_pred_mode represents the intra prediction mode information, and reference_line represents the reference line selection information. is_directional_mode is a variable indicating whether an intra prediction mode of the current block is a directional intra prediction mode. is_directional_mode may not be explicitly signaled, and may be derived based on the intra prediction mode information.

For example, when the coding block is located on (adjacent to) a specific boundary, the reference line selection information may not be signaled. In this case, the value of the reference line selection information is implicitly inferred as 0, and a first left/top reference line may be selected.

In another example, the reference line selection information may be signaled, but an indicated reference line may be set differently. For example, when the coding block is located on (adjacent to) the specific boundary, the reference line selection information may be signaled, but an indicated reference line may be set differently. For example, when the coding block is located on the specific boundary, the reference line selection information may differently indicate a left line number and a top line number. For example, when the coding block is located on the specific boundary, the reference line selection information may selectively indicate one of reference lines 1 to 4 for a left line and indicate only reference line 1 for a top line. In this case, load on a memory buffer may be reduced.

The specific boundary may be a frame boundary, a tile boundary, and/or a superblock boundary. The specific boundary may be a top boundary of a frame, a top boundary of a tile, and/or a top boundary of a superblock.

It is necessary to reconfigure the plurality of reference lines, considering a case where a left line number and a top line number are indicated differently as described above. For example, when reference line 4 is selected for the left line and reference line 1 is selected for the top line, empty spaces may occur between neighboring reference samples according to an existing reference line configuration when performing intra prediction in a top-left direction and adjacent directions thereof.

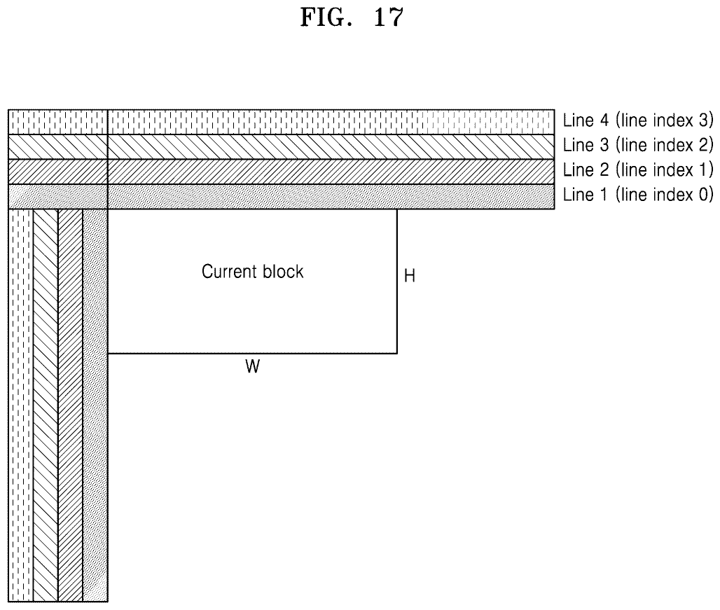

FIG. 17 illustrates an example of multiple lines of neighboring reference samples for intra prediction.

Referring to FIG. 17, a line of neighboring reference samples for a current block may include W+H or more top reference samples, H+W or more left reference samples, and k (e.g., 4) more top-left reference samples. Here, line 1 (reference sample line 1) indicates a reference sample line adjacent to the current block. Line 2 (reference sample line 2) indicates a reference sample line located at a distance of one sample from a left/top boundary of the current block. Line 3 (reference sample line 3) indicates a reference sample line located at a distance of two samples from the left/top boundary of the current block. Line 4 (reference sample line 4) indicates a reference sample line located at a distance of three samples from the left/top boundary of the current block.

The number of top-left reference samples may be the same regardless of a reference sample line number. For example, a top-left reference sample area of line 1 may include four top-left reference samples. A top-left reference sample area of line 2 may include four top-left reference samples. A top-left reference sample area of line 3 may include four top-left reference samples. A top-left reference sample area of line 4 may include four top-left reference samples.

For example, when a reference sample line number increases, the number of top-left reference samples in a top-left reference sample area may not increase, and the number of top reference samples in a top reference sample area may not increase either. For example, the number of top-left reference samples in line n may be equal to the number of top-left reference samples in line n+1, and the number of top reference samples in line n may be equal to the number of top reference samples in line n+1. For example, n may be 1, 2, 3, and the like.

For example, when the reference sample line number increases, the number of top-left reference samples in the top-left reference sample area may not increase, and the number of left reference samples in a left reference sample area may not increase either. For example, the number of top-left reference samples in line n may be equal to the number of top-left reference samples in line n+1, and the number of left reference samples in line n may be equal to the number of left reference samples in line n+1. For example, n may be 1, 2, 3, and the like.

Based on the aforementioned structure, even when a left line number and a top line number are determined differently, there is no empty space between neighboring reference samples, thus smoothly performing intra prediction.

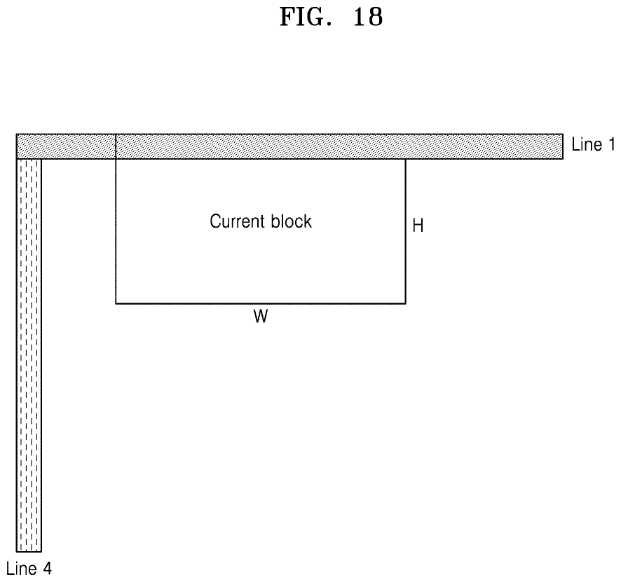

FIG. 18 illustrates an example of configuring neighboring reference sample when a left line number and a top line number are determined differently.

Referring to FIG. 18, a top reference line is a first reference line, and a left reference line is a fourth reference line. In this case, the first top reference line and the fourth left reference line may be connected without any gap, allowing seamless coverage of intra prediction directions. Accordingly, when a left line number and a top line number are determined differently, an error that may occur in a specific intra prediction direction may be avoided.

Referring back to FIG. 17, even when multiple reference lines is used as described above, some of the neighboring reference samples may not yet have been decoded/reconstructed or may not be available. In this case, the coding apparatus may configure neighboring reference samples to be used for intra prediction by padding or substituting unavailable samples with available samples. A reference line index may be denoted as rlidx.

For example, the top reference samples in reference sample line n may be represented as AboveRow[i], where i may have a value of 0 to W+H−1. When the top reference samples are unavailable, if the left reference samples are available, one of the left reference samples may be used as a sample value for the top reference samples. Specifically, for example, the unavailable top reference samples may be padded or substituted to be identical to an uppermost reference sample among the left neighboring reference samples. That is, the unavailable top reference samples may be padded or substituted to be identical to a left reference sample at a coordinate (x−1−rlidx, y). Here, (x, y) may represent the position of the top-left sample of the current block (e.g., a coding block or transform block). When the top reference samples are unavailable and the left reference samples are also unavailable, the top reference samples may be padded or substituted with a default value derived based on a predetermined bit depth. The default value may be set to, for example, (1<<(BitDepth−1))−1. Alternatively, the unavailable top reference samples may be padded or substituted to be identical to the top-left reference sample at a coordinate (x−1, y−1−rlidx).

When the top reference samples are available, reconstructed sample values of the top reference samples are basically used as values of the top reference samples. When the top reference samples are available, a first parameter may be determined. The first parameter may be determined as, for example, x+2W−1. When H>W, the reconstructed sample values are not used for specific top reference samples having an x-coordinate greater than the first parameter, and a value of a top reference sample having an x-coordinate of the first parameter is copied (padded or substituted) for the specific top reference samples. That is, for the specific top reference samples, a value of a top reference sample at a coordinate (first parameter, y−1) may be copied (padded or substituted). Alternatively, when H>W, a value of a 2W-th top reference sample may be copied (padded or substituted) for top reference samples after the 2W-th top reference sample.

The left reference samples may be represented, for example, as LeftCol[i], where i may have a value of 0 to W+H−1. When the left samples are unavailable, if the top reference samples are available, one of the top reference samples may be used as a sample value for the left reference samples. Specifically, for example, the unavailable left reference samples may be padded or substituted to be identical to a leftmost reference sample among the top neighboring reference samples. That is, the unavailable left reference samples may be padded or substituted to be identical to a top reference sample at a coordinate (x, y−1−rlidx). Here, (x, y) may represent the position of the top-left sample of the current block (e.g., a coding block or transform block). When the left reference samples are unavailable and the top reference samples are also unavailable, the left reference samples may be padded or substituted with a default value derived based on a predetermined bit depth. The default value may be set to, for example, (1<<(BitDepth−1))−1. Alternatively, the unavailable left reference samples may be padded or substituted to be identical to the top-left reference sample at a coordinate (x−1−rlidx, y−1). The unavailable left reference samples may be padded or substituted to be identical to the top-left reference samples in reference line 1.

When the left reference samples are available, reconstructed sample values of the left reference samples are basically used as values of the left reference samples. When the left reference samples are available, a second parameter may be determined. The second parameter may be determined as, for example, x+2H−1. When W>H, the reconstructed sample values are not used for specific left reference samples having a y-coordinate greater than the second parameter, and a value of a left reference sample having a y-coordinate of the second parameter is copied (padded or substituted) for the specific left reference samples. That is, for the specific left reference samples, a value of a left reference sample at a coordinate (x−1, second parameter) may be copied (padded or substituted). Alternatively, when W>H, a value of a 2H-th left reference sample may be copied (padded or substituted) for left reference samples after the 2H-th left reference sample.

The top-left reference samples may be represented as AboveRow[−i] for convenience, where i may include 1 to k (e.g., k is 4). When the top-left reference sample is available, a reconstructed sample value of the reference sample is used. When the top-left reference sample is unavailable, a value of an available left reference sample at a coordinate ((x−1−rlidx, y) or an available top reference sample at a coordinate (x, y−1−rlidx) may be copied (padded or substituted). When the top-left reference samples are unavailable and both the left reference sample and top reference sample are unavailable, the top-left reference samples may be padded or substituted with a default value derived based on a given bit depth. The default value may be set to, for example, (1<<(BitDepth−1))−1.

When the left line number and the top line number are determined differently, reference samples used for padding may be configured differently.

For example, when the left line number and the top line number are determined differently, an available reference sample used for padding may be a reference sample in the same reference line. Specifically, when the top reference line is determined as reference line 1 and the left reference line is determined as reference line n based on rlidx, a left reference sample in left reference line 1 is used for padding a reference sample in top reference line 1. For example, a left reference sample at a coordinate (x−1, y) in left reference line 1 may be used for padding the reference sample in the top reference line 1. When a top-left reference sample in reference line 1 is unavailable, the left reference sample at the coordinate (x−1, y) in left reference line 1 or a top reference sample at a coordinate (x, y−1) in top reference line 1 may be copied (padded or substituted).

In another example, when the left line number and the top line number are determined differently, an available reference sample used for padding may be a reference sample in a different reference line. Specifically, when the top reference line is determined as reference line 1 and the left reference line is determined as reference line n based on rlidx, a left reference sample in left reference line n is used for padding a reference sample in top reference line 1. For example, a left reference sample at a coordinate (x−1−rlidx, y) in left reference line n may be used for padding the reference sample in top reference line 1. When a top-left reference sample in reference line 1 is unavailable, the left reference sample at the coordinate (x−1−rlidx, y) in left reference line n or a top reference sample at a coordinate (x, y−1−rlidx) in top reference line 1 may be copied (padded or substituted).

Multiple reference line selection may be applied only to some directional prediction modes. For example, multiple reference line selection may be applied only when the aforementioned angle delta value is non-zero. Alternatively, multiple reference line selection may be applied when an intra prediction mode is neither a vertical mode nor a horizontal mode.

In some cases, two or more reference lines may be selected. For example, a multiple reference line index may indicate the following.

TABLE 10

| Reference line index | Description |
|---|---|
| 0 | Reference line 1 |
| 1 | Reference line 2 |
| 2 | Reference line 3 |
| 3 | Reference line 4 |
| 4 | Reference lines 1 and 2 |
| 5 | Reference lines 2 and 3 |
| 6 | Reference lines 3 and 4 |
| 7 | Reference lines 1 and 4 |

When two or more reference lines are selected as described above, a first prediction block may be generated for selected reference line n according to an intra prediction direction, a second prediction block may be generated for selected reference line k according to a intra prediction direction, and a final prediction block may be generated based on a weighted sum of the first prediction block and second prediction block.

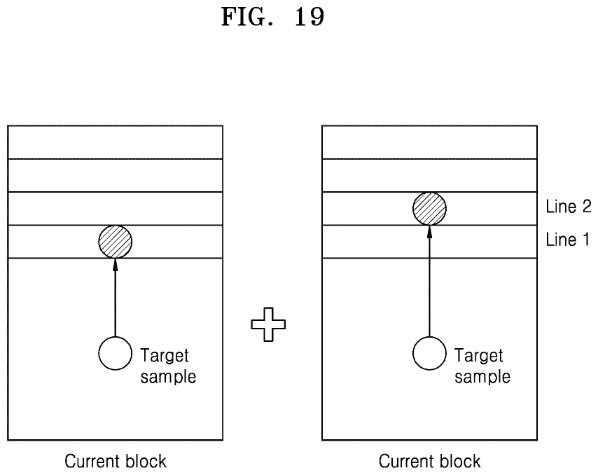

FIG. 19 illustrates an example of generating a final prediction block through a weighted sum of two prediction blocks based on multiple reference lines according to an intra prediction mode.

Referring to FIG. 19, reference line 1 and reference line 2 may be selected, and a weighted sum may be obtained by performing first prediction based on reference line 1 and second prediction based on reference line 2 according to a derived intra prediction mode (intra prediction direction).

Further, when the intra prediction direction points to a fractional sample position, a prediction sample may be generated using a two-dimensional interpolation filter based on two reference samples in reference line n and two reference samples in reference line k adjacent to the fractional sample position.

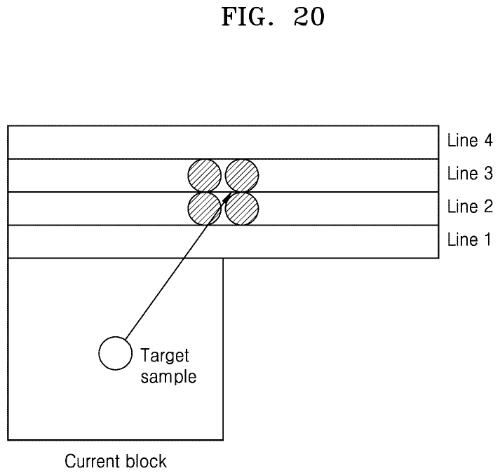

FIG. 20 illustrates an example of generating an intra prediction sample through two-dimensional interpolation.

Referring to FIG. 20, when multiple reference lines is selected, a prediction sample may be generated by interpolating four or more reference samples located adjacent to an intra prediction direction relative to a target sample, thereby improving intra prediction performance.

Filtering may be performed on derived neighboring reference samples before generating an intra prediction sample. Depending on cases, a 3-tap filter or a 5-tap filter may be applied for filtering the reference samples. For example, an edge filter strength may be derived based on a block size and/or an angle delta value, and a filtering procedure may be performed based on the edge filter strength. When the edge filter strength is 0, filtering may be omitted. The aforementioned reference sample filtering may be performed on a reference line basis, or cross-line filtering may be performed. That is, filtering using samples in multiple reference lines may be performed.

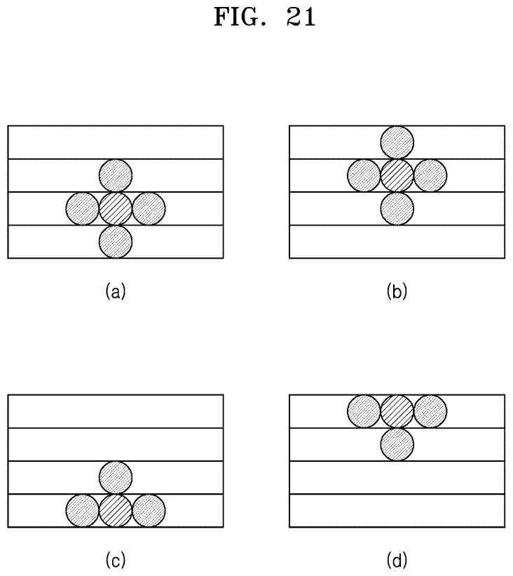

FIG. 21 illustrates an example of cross-line filtering for reference samples.

Referring to FIG. 21, as illustrated in (a) and (b) of FIG. 19, for reference samples in reference line 2 or 3, filtering may be performed using four neighboring reference samples located above, below, left, and right of a target reference sample. For example, when the target reference sample is located in reference line 2, two neighboring reference samples in reference line 2, one reference sample in reference line 3, and one reference sample in reference line 1 may be used for filtering. For example, when the target reference sample is located in reference line 3, two neighboring reference samples in reference line 3, one reference sample in reference line 4, and one reference sample in reference line 2 may be used for filtering.

As illustrated in (c) and (d) of FIG. 21, for reference samples in reference line 1 or 4, filtering may be performed using three neighboring reference samples of a target reference sample. For example, when the target reference sample is located in reference line 1, two neighboring reference samples in reference line 1 and one reference sample in reference line 2 may be used for filtering. For example, when the target reference sample is located in reference line 4, two neighboring reference samples in reference line 4 and one reference sample in reference line 3 may be used for filtering.

Whether cross-line filtering for the above reference samples is allowed may be signaled via high-level syntax (e.g., a sequence header or a frame header, or tile header). When cross-line filtering is allowed, cross-line filtering may be performed as described above. When cross-line filtering is not allowed, line-based filtering may be performed.

The number of taps of an interpolation filter and/or type of an interpolation filter may be set differently for each reference line. For example, a k-tap interpolation filter may be applied to reference line 1, and an n-tap interpolation filter may be applied to reference line 2. For example, k may be 4 or 6, and n may be 2, 3, or 5. In this case, the k-tap interpolation filter may be a combined filter (CF), and the k-tap interpolation filter may be a bilinear filter (BF). For example, after reference sample filtering is applied, an interpolation filter may be applied when an intra prediction direction points to a fractional sample position in prediction according to the intra prediction direction. When the k-tap interpolation filter is applied, reference sample filtering may be omitted.

When a reference line other than reference line 1 is selected through multiple reference line selection, a first prediction block may be generated using a non-directional intra prediction mode for reference line 1, and a second prediction block may be generated using a directional intra prediction mode for the selected reference line. In this case, a final prediction block may be generated through a weighted sum of the first prediction block and the second prediction block. For example, the non-directional intra prediction mode may include a DC intra prediction mode and/or a SMOOTH intra prediction mode. The SMOOTH intra prediction mode may include SMOOTH_PRED, SMOOTH_V_PRED, and/or SMOOTH_H_PRED. In SMOOTH_V_PRED, a prediction sample may be generated through interpolation (or distance-based weighted averaging) using a vertical top neighboring sample and further using a bottommost left neighboring sample among left neighboring samples. In SMOOTH_H_PRED, a prediction sample may be generated through interpolation (or distance-based weighted averaging) using a horizontal left neighboring sample and further using a rightmost top neighboring sample among top neighboring samples. In SMOOTH PRED, a prediction sample may be generated based on bidirectional interpolation of a vertical top neighboring sample, a bottommost left neighboring sample among left neighboring samples, a horizontal left neighboring sample, and a rightmost top neighboring sample among the top neighboring samples. Whether to combine with the prediction block using the non-directional intra prediction mode may be signaled through additional information. The additional information may include IBP information. For example, when a reference line index is greater than 0 and IBP is applied to the current block, a first prediction block may be generated using a non-directional intra prediction mode for reference line 1, and a second prediction block may be generated using a directional intra prediction mode for the selected reference line, thereby calculating a weighted sum of the first prediction block and the second prediction block.

When MRLS is applied as described above (or when the reference line index is greater than 0), an intra prediction mode for the current block among intra prediction modes within a predetermined set may be signaled. For example, the intra prediction mode for the current block may be determined only from a first mode set among a plurality of mode sets, in which case mode set index information may not be explicitly coded/signaled. In this case, the decoding apparatus may consider that the first mode set is selected without explicitly parsing/signaling the mode set index information. The first mode set may correspond to a mode set with a highest priority (rank) indicated when a value of the mode set index information is 0. In this case, the index of the intra prediction mode applied to the current block within the first mode set may be indicated based on signaling of mode index information without signaling a mode set index. Accordingly, it is possible to reduce complexity and the number of bits required for mode signaling, while improving intra prediction efficiency by using a high-priority intra prediction mode.

Reference line candidates may be configured differently depending on cases. That is, a reference line candidate set may be adaptively determined from among a plurality of reference line candidate sets.

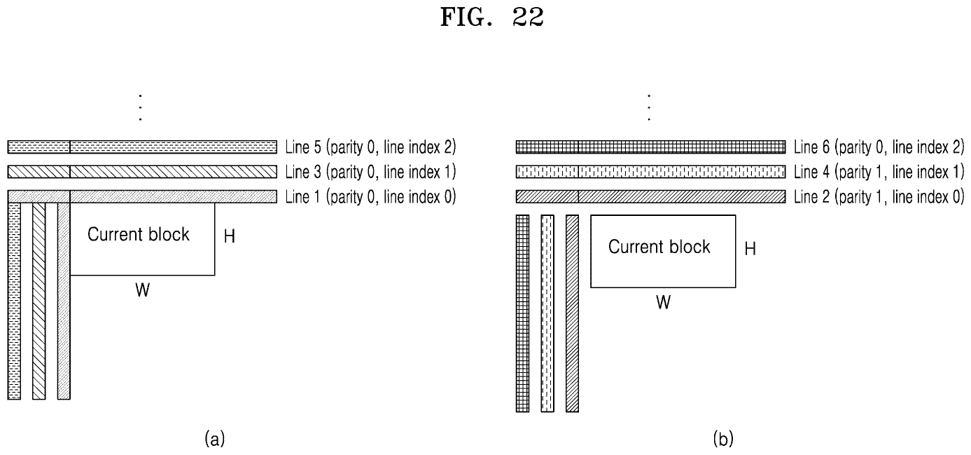

FIG. 22 illustrates an example of setting reference line candidates differently.

Referring to FIG. 22, in (a), reference line indices 0 to 2 are used to include reference line 1, reference line 3, and reference line 5 as candidates, and in (b), reference line indices 0 to 2 are used to include reference line 2, reference line 4, and reference line 6 as candidates. In this example, the same line index values are used, but the line candidates are set differently based on a parity value. That is, a reference line candidate set may be determined based on the parity value among a plurality of reference line candidate sets.

The parity value may be implicitly derived or may be explicitly signaled through a bitstream. For example, the parity value may be signaled through a parity flag, and signaling thereof may be omitted according to a specific condition. The specific condition may include whether a block size is within a predetermined range and whether the block is square or non-square. When signaling of the parity flag is omitted, a default value of 0 may be derived.

Additionally or alternatively to the specific condition, the parity flag for the MRLS may be determined/signaled based on a value of a line index for the MRLS. For example, the parity flag may be signaled when the line index is greater than 0.

TABLE 11

```
...
    reference_line
  if(reference_line)
    line_parity
...
```

reference_line represents reference line selection information (i.e., the reference line index), and line parity represents the parity flag for MRLS. When the value of reference line is greater than 0, line_parity may be explicitly signaled.

As described above, when the parity flag for the MRLS is determined/signaled based on the value of the line index for the MRLS, reference line candidates may be configured, for example, as follows.

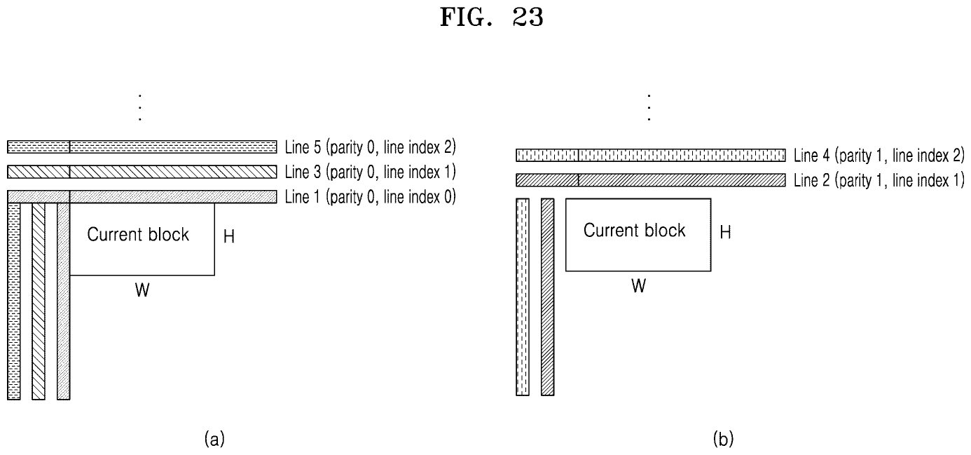

FIG. 23 illustrates another example of setting reference line candidates differently.

Referring to FIG. 23, in (a), reference line indices 0 to 2 are used to include reference line 1, reference line 3, and reference line 5 as candidates, and in (b), reference line indices 1 to 2 are used to include reference line 2 and reference line 4 as candidates. In this example, when the reference line index is 0, a parity flag is implicitly derived as 0. Accordingly, the number of line candidates when the parity flag is 0 is different from the number of line candidates when the parity flag is 1. Specifically, the number of line candidates when the parity flag is 1 may be one fewer than the number of line candidates when the parity flag is 0. When the reference line candidates are set differently as described above, various line candidates may be adaptively indicated, and signaling efficiency may also be improved since the candidates may be implicitly determined depending on conditions.

According to the above-described embodiment(s), neighboring reference samples of multiple reference lines may be efficiently derived in consideration of square/non-square shapes of a block, and intra prediction may be efficiently performed. In addition, intra prediction mode candidates may be determined in consideration of multiple reference lines, and intra prediction mode signaling may be efficiently performed. Further, a left line and a top line may be determined differently, and a reference line configuration therefor may be constructed. In addition, filtering and/or prediction using two or more lines among multiple reference lines may be performed. Further, various reference lines may be efficiently used by setting reference line candidates differently according to conditions.

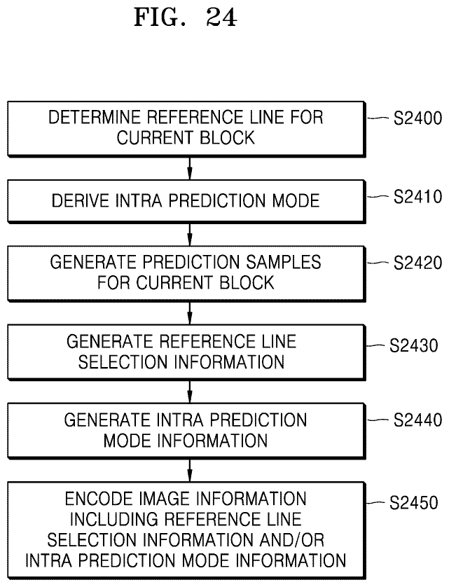

FIG. 24 schematically illustrates a video/image encoding method according to an embodiment(s) of the disclosure. The method disclosed in FIG. 24 may be performed by the encoding apparatus 200 disclosed in FIG. 2. Specifically, for example, S2400 to S2440 of FIG. 24 may be performed by predictor 220 of the encoding apparatus 200, and S2450 may be performed by the entropy encoder 240 of the encoding apparatus 200. The method disclosed in FIG. 24 may include the foregoing embodiments of the disclosure.

Referring to FIG. 24, an encoding apparatus determines a reference line for a current block (S2400). The reference line may be based on various multiple reference lines (or reference line samples) described in the present disclosure. The reference line may be one of a plurality of reference line candidates neighboring the current block. The reference line may include a left reference line and a top reference line. The encoding apparatus may derive an optimal reference line for the current block based on various intra prediction modes with respect to the reference line candidates.

For example, among the plurality of reference line candidates, the number of top-left reference samples of an (n+1)-th reference line may be greater than the number of top-left reference samples of an n-th reference line, and the number of top reference samples of the n-th reference line may be equal to the number of top reference samples of the (n+1)-th reference line.

For example, among the plurality of reference line candidates, the number of top-left reference samples of an (n+1)-th reference line may be greater than the number of top-left reference samples of an n-th reference line, and the number of left reference samples of the n-th reference line may be equal to the number of left reference samples of the (n+1)-th reference line.

For example, among the plurality of reference line candidates, the number of top-left reference samples of an n-th reference line may be equal to the number of top-left reference samples of an (n+1)-th reference line, and the number of top reference samples of the n-th reference line may be equal to the number of top reference samples of the (n+1)-th reference line.

For example, among the plurality of reference line candidates, the number of top-left reference samples of an n-th reference line may be equal to the number of top-left reference samples of an (n+1)-th reference line, and the number of left reference samples of the n-th reference line may be equal to the number of left reference samples of the (n+1)-th reference line.

The encoding apparatus derives an intra prediction mode for the current block (S2410). The encoding apparatus may derive an optimal intra prediction mode for the reference line. S2410 may be performed simultaneously with S2400 or may be performed before S2400. That is, the encoding apparatus may derive an optimal reference line and an optimal intra prediction mode for the current block based on various intra prediction modes with respect to the reference line candidates.

The encoding apparatus generates prediction samples for the current block (S2420). The encoding apparatus generates the prediction samples for the current block based on the reference line and the intra prediction mode.

For example, the reference line selection information may indicate two reference line candidates among the plurality of reference line candidates, the determined reference line may include a first reference line and a second reference line, a first prediction block may be generated based on the first reference line and the intra prediction mode, and a second prediction block may be generated based on the second reference line and the intra prediction mode, and prediction samples for the current block may be generated based on a weighted sum of the first prediction block and the second prediction block.

For example, the reference line selection information may indicate two reference line candidates among the plurality of reference line candidates, the determined reference line may include a first reference line and a second reference line, two reference samples of the first reference line may be derived based on an intra prediction direction corresponding to the intra prediction mode, two reference samples of the second reference line may be derived based on the intra prediction direction, and a prediction sample of the current block may be generated based on interpolation of the two reference samples of the first reference line and the two reference samples of the second reference line.

For example, in order to generate prediction samples for the current block based on the determined reference line and the intra prediction mode, reference samples of the determined reference line may be derived, filtering may be performed on the reference samples, and prediction samples for the current block may be generated based on the filtered reference samples and the intra prediction mode. In this case, in order to perform filtering on the reference samples, two same-line reference samples neighboring a target reference sample of the determined reference line may be derived, one neighboring-line reference sample of at least one neighboring reference line adjacent to the determined reference line may be derived, and filtering of the target reference sample may be performed based on the two same-line reference samples and the one neighboring-line reference sample.

For example, in order to generate prediction samples for the current block based on the determined reference line and the intra prediction mode, reference samples of the determined reference line may be derived, and prediction samples for the current block may be generated based on the derived reference samples and the intra prediction mode. In this case, in order to derive the reference samples, when top reference samples of the current block are not available, the unavailable top reference samples may be set to be equal to a left reference sample at coordinates (x−1−rlidx, y), where (x, y) represents a top-left sample position of the current block, and rlidx may represent an index value of the reference line selection information. For example, when left reference samples of the current block are not available, the unavailable left reference samples may be set to be equal to a top reference sample at coordinates (x, y−1−rlidx), where (x, y) represents the top-left sample position of the current block, and rlidx may represent the index value of the reference line selection information. For example, when a top-left reference sample (or samples) of the current block is not available, a value of an available left reference sample at coordinates (x−1−rlidx, y) or an available top reference sample at coordinates (x, y−1−rlidx) may be copied (padded or substituted). When the top-left reference sample is not available and the left reference samples and the top reference samples are also not available, the top-left reference samples may be padded or substituted with a default value derived based on a predetermined bit depth. Here, the default value may be set to, for example, (1<<(BitDepth−1))−1.

For example, in order to generate prediction samples for the current block based on the determined reference line and the intra prediction mode, reference samples of the determined reference line may be derived, and prediction samples for the current block may be generated based on the derived reference samples and the intra prediction mode. In this case, when the current block is a non-square block and a height of the current block is greater than a width thereof, a first parameter may be derived, and specific top reference samples having x-coordinates greater than the first parameter may be set to be equal to a value of a top reference sample having an x-coordinate corresponding to the first parameter. Alternatively, if H>W, values of top reference samples after a 2W-th top reference sample may be copied (padded or substituted) from the value of the 2W-th top reference sample.

For example, in order to generate prediction samples for the current block based on the determined reference line and the intra prediction mode, reference samples of the determined reference line may be derived, and prediction samples for the current block may be generated based on the derived reference samples and the intra prediction mode. In this case, when the current block is a non-square block and a width of the current block is greater than a height thereof, a second parameter may be derived, and specific left reference samples having y-coordinates greater than the second parameter may be set to be equal to a value of a left reference sample having a y-coordinate corresponding to the second parameter. Alternatively, if W>H, values of left reference samples after a 2H-th left reference sample may be copied (padded or substituted) from the value of the 2H-th left reference sample.

The encoding apparatus generates reference line selection information (S2430). The reference line selection information may indicate a reference line candidate among a plurality of reference line candidates.

The current block may be a transform block, and the transform block may be located within a coding block. The reference line may include a left reference line and a top reference line, and when the coding block including the transform block is located adjacent to a specific boundary, a number of the top reference line may be determined differently from a number of the left reference line. For example, the number of the left reference line may be variably indicated based on the reference line selection information, and the number of the top reference line may be derived as reference line 1.

For example, the encoding apparatus may determine a reference line candidate set among a plurality of reference line candidate sets. In this case, the reference line selection information may indicate the reference line within the determined reference line candidate set. The reference line candidate set among the plurality of reference line candidate sets may be indicated based on a condition and/or signaled information.

The encoding apparatus generates intra prediction mode information (S2440). The encoding apparatus generates the intra prediction mode information related to the intra prediction mode.

For example, when a value of the reference line selection information is 0, the intra prediction mode information may include mode set index information and mode index information. When the value of the reference line selection information is not 0, the intra prediction mode information may include only the mode index information among the mode set index information and the mode index information.

For example, when the value of the reference line selection information is not 0, signaling of the mode set index information may be omitted, and the mode index information may indicate one of intra prediction mode candidates of a first mode set.

The encoding apparatus encodes image information including the reference line selection information and/or the intra prediction mode information (S2450). In some cases, one of the reference line selection information and/or the intra prediction mode information may be omitted.

The image information may further include parity information. The parity information may be used to indicate the reference line candidate set among the plurality of reference line candidate sets. When the parity information indicates a first value, a reference line candidate set including reference line candidates having odd line numbers may be determined, and when the parity information indicates a second value, a reference line candidate set including reference line candidates having even line numbers may be determined.

For example, the parity information may be signaled after the reference line selection information, and the parity information may be signaled when a value of the reference line selection information is not 0. The parity information may not be explicitly encoded/signaled when a size of the current block is smaller than a predetermined value.

When an intra prediction type of the current block is a specific type, for example, IBP (intra bi-prediction), RIP (recursive intra prediction) or the like, the reference line selection information may not be explicitly encoded/signaled.

The image information may be referred to as video information. The image information may include various information according to embodiments of the present disclosure. For example, the image information may include the information described above in the present disclosure.

Meanwhile, the image information may include residual information. The residual information is information related to residual samples. The residual information may include information related to quantized transform coefficients for the residual samples.

The encoded image information may be output in the form of a bitstream. The bitstream may be transmitted to a decoding apparatus through a network or a storage medium. For example, image data including the bitstream may be transmitted to the decoding apparatus by a transmitting apparatus (or a transmitter). In this case, the image data including the bitstream may be transmitted to the decoding apparatus through a streaming server.

In addition, as described above, the encoding apparatus may generate a reconstructed frame (including reconstructed samples and a reconstructed block) based on the prediction samples and the residual samples. This is because the encoding apparatus derives the same prediction result as that performed in the decoding apparatus, and coding efficiency may thereby be improved. Accordingly, the encoding apparatus may store the reconstructed frame (or reconstructed samples or a reconstructed block) in a memory and may use the reconstructed frame as reference samples for intra prediction or as a reference frame for inter prediction. As described above, an in-loop filtering procedure or the like may be further applied to the reconstructed frame.

According to the above-described embodiment(s), neighboring reference samples of multiple reference lines may be efficiently derived in consideration of square/non-square shapes of a block, and intra prediction may be efficiently performed. In addition, intra prediction mode candidates may be determined in consideration of multiple reference lines, and intra prediction mode signaling may be efficiently performed. Further, a left line and a top line may be determined differently, and a reference line configuration therefor may be constructed. In addition, filtering and/or prediction using two or more lines among multiple reference lines may be performed. Further, various reference lines may be efficiently used by setting reference line candidates differently according to conditions.

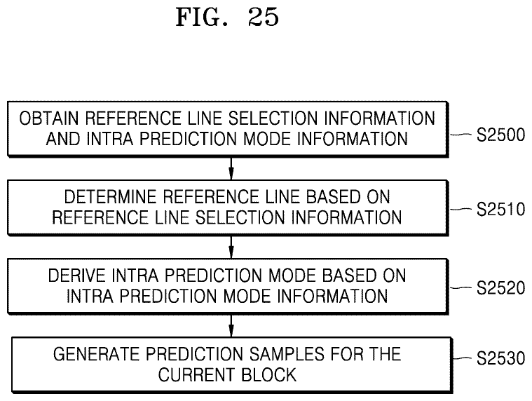

FIG. 25 schematically illustrates a video/image decoding method according to an embodiment(s) of the disclosure. The method disclosed in FIG. 25 may be performed by the decoding apparatus disclosed in FIG. 3. Specifically, for example, S2500 of FIG. 25 may be performed by the entropy decoder 310 of the decoding apparatus 300, and S2510 to S2530 of FIG. 25 may be performed by the predictor 330 of the decoding apparatus 300. The method disclosed in FIG. 25 may include the foregoing embodiments of the disclosure.

Referring to FIG. 25, a decoding apparatus obtains reference line selection information and intra prediction mode information (S2500). The decoding apparatus may obtain image information including the reference line selection information and/or the intra prediction mode information through a bitstream. The image information may further include, as described above, transform information, residual information, and the like.

The image information may further include parity information. The parity information may be used to indicate the reference line candidate set among a plurality of reference line candidate sets. When the parity information indicates a first value, a reference line candidate set including reference line candidates having odd line numbers may be determined, and when the parity information indicates a second value, a reference line candidate set including reference line candidates having even line numbers may be determined.

For example, the parity information may be signaled after the reference line selection information, and the parity information may be signaled when a value of the reference line selection information is not 0. The parity information may not be explicitly encoded/signaled when a size of the current block is smaller than a predetermined value.

When an intra prediction type of the current block is a specific type, for example, IBP (intra bi-prediction), RIP (recursive intra prediction), or the like, the reference line selection information may not be explicitly encoded/signaled.

The image information may be referred to as video information. The image information may include various information according to embodiments of the present disclosure. For example, the image information may include the information described above in the present disclosure.

The decoding apparatus determines a reference line for the current block based on the reference line selection information (S2510). The reference line may be based on various multiple reference lines (or reference line samples) described in the present disclosure. The reference line may be one of a plurality of reference line candidates neighboring the current block. The reference line may include a left reference line and a top reference line.

For example, among the plurality of reference line candidates, the number of top-left reference samples of an (n+1)-th reference line may be greater than the number of top-left reference samples of an n-th reference line, and the number of top reference samples of the n-th reference line may be equal to the number of top reference samples of the (n+1)-th reference line.

For example, among the plurality of reference line candidates, the number of top-left reference samples of an (n+1)-th reference line may be greater than the number of top-left reference samples of an n-th reference line, and the number of left reference samples of the n-th reference line may be equal to the number of left reference samples of the (n+1)-th reference line.

For example, among the plurality of reference line candidates, the number of top-left reference samples of an n-th reference line may be equal to the number of top-left reference samples of an (n+1)-th reference line, and the number of top reference samples of the n-th reference line may be equal to the number of top reference samples of the (n+1)-th reference line.

For example, among the plurality of reference line candidates, the number of top-left reference samples of an n-th reference line may be equal to the number of top-left reference samples of an (n+1)-th reference line, and the number of left reference samples of the n-th reference line may be equal to the number of left reference samples of the (n+1)-th reference line.

The reference line selection information may indicate a reference line candidate among a plurality of reference line candidates. For example, a reference line candidate set may be determined among a plurality of reference line candidate sets. The reference line candidate set among the plurality of reference line candidate sets may be indicated or determined based on a condition and/or signaled information. In this case, the reference line selection information may indicate the reference line within the determined reference line candidate set. For example, the parity information may indicate the reference line candidate set among the plurality of reference line candidate sets.

The current block may be a transform block, and the transform block may be located within a coding block. The reference line may include a left reference line and a top reference line, and when the coding block including the transform block is located adjacent to a specific boundary, a number of the top reference line may be determined differently from a number of the left reference line. For example, the number of the left reference line may be variably indicated based on the reference line selection information, and the number of the top reference line may be derived as reference line 1.

The decoding apparatus derives an intra prediction mode for the current block based on the intra prediction mode information (S2520). S2520 may be performed simultaneously with S2510 or may be performed before S2510. The intra prediction mode information may indicate one of the intra prediction modes described above.

For example, when a value of the reference line selection information is 0, the intra prediction mode information may include mode set index information and mode index information. When the value of the reference line selection information is not 0, the intra prediction mode information may include only the mode index information among the mode set index information and the mode index information.

For example, when the value of the reference line selection information is not 0, signaling of the mode set index information may be omitted, and the mode index information may indicate one of intra prediction mode candidates in a first mode set.

The decoding apparatus generates prediction samples for the current block (S2530). The decoding apparatus generates the prediction samples for the current block based on the reference line and the intra prediction mode.

For example, the reference line selection information may indicate two reference line candidates among the plurality of reference line candidates, the determined reference line may include a first reference line and a second reference line, a first prediction block may be generated based on the first reference line and the intra prediction mode, and a second prediction block may be generated based on the second reference line and the intra prediction mode, and prediction samples for the current block may be generated based on a weighted sum of the first prediction block and the second prediction block.

For example, the reference line selection information may indicate two reference line candidates among the plurality of reference line candidates, the determined reference line may include a first reference line and a second reference line, two reference samples of the first reference line may be derived based on an intra prediction direction corresponding to the intra prediction mode, two reference samples of the second reference line may be derived based on the intra prediction direction, and a prediction sample of the current block may be generated based on interpolation of the two reference samples of the first reference line and the two reference samples of the second reference line.

For example, in order to generate prediction samples for the current block based on the determined reference line and the intra prediction mode, reference samples of the determined reference line may be derived, filtering may be performed on the reference samples, and prediction samples for the current block may be generated based on the filtered reference samples and the intra prediction mode. In this case, in order to perform filtering on the reference samples, two same-line reference samples neighboring a target reference sample of the determined reference line may be derived, one neighboring-line reference sample of at least one neighboring reference line adjacent to the determined reference line may be derived, and filtering of the target reference sample may be performed based on the two same-line reference samples and the one neighboring-line reference sample.

For example, in order to generate prediction samples for the current block based on the determined reference line and the intra prediction mode, reference samples of the determined reference line may be derived, and prediction samples for the current block may be generated based on the derived reference samples and the intra prediction mode. In this case, in order to derive the reference samples, when top reference samples of the current block are not available, the unavailable top reference samples may be set to be equal to a left reference sample at coordinates (x−1−rlidx, y), where (x, y) represents a top-left sample position of the current block, and rlidx may represent an index value of the reference line selection information. For example, when left reference samples of the current block are not available, the unavailable left reference samples may be set to be equal to a top reference sample at coordinates (x, y−1−rlidx), where (x, y) represents the top-left sample position of the current block, and rlidx may represent the index value of the reference line selection information. For example, when a top-left reference sample (or samples) of the current block is not available, a value of an available left reference sample at coordinates (x−1−rlidx, y) or an available top reference sample at coordinates (x, y−1−rlidx) may be copied (padded or substituted). When the top-left reference sample is not available and the left reference samples and the top reference samples are also not available, the top-left reference samples may be padded or substituted with a default value derived based on a predetermined bit depth. Here, the default value may be set to, for example, (1<<(BitDepth−1))−1.

For example, in order to generate prediction samples for the current block based on the determined reference line and the intra prediction mode, reference samples of the determined reference line may be derived, and prediction samples for the current block may be generated based on the derived reference samples and the intra prediction mode. In this case, when the current block is a non-square block and a height of the current block is greater than a width thereof, a first parameter may be derived, and specific top reference samples having x-coordinates greater than the first parameter may be set to be equal to a value of a top reference sample having an x-coordinate corresponding to the first parameter. Alternatively, if H>W, values of top reference samples after a 2W-th top reference sample may be copied (padded or substituted) from the value of the 2W-th top reference sample.

For example, in order to generate prediction samples for the current block based on the determined reference line and the intra prediction mode, reference samples of the determined reference line may be derived, and prediction samples for the current block may be generated based on the derived reference samples and the intra prediction mode. In this case, when the current block is a non-square block and a width of the current block is greater than a height thereof, a second parameter may be derived, and specific left reference samples having y-coordinates greater than the second parameter may be set to be equal to a value of a left reference sample having a y-coordinate corresponding to the second parameter. Alternatively, if W>H, values of left reference samples after a 2H-th left reference sample may be copied (padded or substituted) from the value of the 2H-th left reference sample.

For example, the decoding apparatus may derive a prediction block and a residual block by performing a series of procedures such as prediction and transform on the derived current block, and may generate a reconstructed block (a reconstructed frame) based on the prediction block and the residual block.

For example, prediction samples for the current coding block may be generated based on the derived intra prediction mode and neighboring reference samples of the reference line. The decoding apparatus may generate reconstructed samples based on prediction samples of the current block. For example, the decoding apparatus may generate the reconstructed samples for the current block based on residual samples for the current block and the prediction samples. The residual samples for the current block may be generated based on received residual information. In addition, the decoding apparatus may, for example, generate a reconstructed frame including the reconstructed samples. As described above, an in-loop filtering procedure or the like may be further applied to the reconstructed frame.

According to the above-described embodiment(s), neighboring reference samples of multiple reference lines may be efficiently derived in consideration of square/non-square shapes of a block, and intra prediction may be efficiently performed. In addition, intra prediction mode candidates may be determined in consideration of multiple reference lines, and intra prediction mode signaling may be efficiently performed. Further, a left line and a top line may be determined differently, and a reference line configuration therefor may be constructed. In addition, filtering and/or prediction using two or more lines among multiple reference lines may be performed. Further, various reference lines may be efficiently used by setting reference line candidates differently according to conditions.

Although the methods are described based on a flowchart as a series of steps or blocks in the aforementioned embodiments, the embodiments are not limited to the order of the steps, and a certain step may occur in a different order or concurrently with another step described above. Furthermore, it will be understood by those skilled in the art that the steps shown in the flowchart are not exclusive, and that other steps may be included or one or more steps in the flowchart may be deleted without affecting the scope of the embodiments of the disclosure

The aforementioned methods according to the embodiments of the disclosure may be implemented in software form, and the encoding apparatus and/or the decoding apparatus according to the disclosure may be included in a device for performing image processing, for example, a TV, a computer, a smartphone, a set-top box, and a display device.

The aforementioned embodiments of the disclosure may be implemented in the form of a recording medium including a computer-executable (program) instruction, such as a program module executed by a computer. The module may be stored in a memory and executed by a processor. The memory may reside inside or outside the processor, and may be connected to the processor by various well-known means. A computer-readable medium may be any available medium accessible by a computer, and may include both volatile and nonvolatile media and removable and non-removable media. Furthermore, the computer-readable medium may include both a computer storage medium and a communication medium. The computer storage medium may include both volatile and nonvolatile media and removable and non-removable media implemented in any method or technology for storing information, such as a computer-readable instruction, a data structure, a program module, or other data. The communication medium typically includes a computer-readable instruction, a data structure, a program module, other data in a modulated data signal such as a carrier wave, or other transfer mechanisms, and includes any information delivery medium.

Furthermore, the embodiments of the disclosure described above may be implemented as a computer program (or computer program product) including a computer-executable instruction. The computer program may include a programmable machine instruction processed by a processor, and may be implemented in a high-level programming language, an object-oriented programming language, an assembly language, or a machine language. In addition, the computer program may be recorded in a tangible computer-readable recording medium (e.g., a memory, a hard disk, a magnetic/optical medium, or a solid-state drive (SSD).

Therefore, the embodiments of the disclosure may be implemented as the aforementioned computer program is executed by a computing device. The computing device may include at least some of a processor, a memory, a storage device, a high-speed interface connected to the memory and a high-speed expansion port, and a low-speed interface connected to a low-speed bus and the storage device. These components may be interconnected via various buses, and may be mounted on a common motherboard or in other suitable manners.

The processor may process an instruction within the computing device. The instruction may include an instruction stored in the memory or the storage device to display graphical information for providing a graphical user interface (GUI) on an external input/output device, such as a display connected to the high-speed interface. In another embodiment, a plurality of processors and/or a plurality of buses may be utilized appropriately along with a plurality of memories and memory types. Further, the processor may be implemented as a chipset of chips including a plurality of independent analog and (or) digital processors.

The memory stores information within the computing device. For example, the memory may include a volatile memory unit or a set of volatile memory units. In another example, the memory may include a nonvolatile memory unit or a set of nonvolatile memory units. The memory may also be another form of computer-readable medium, such as a magnetic or optical disk.

The storage device may provide a high-capacity storage space for the computing device. The storage device may be a computer-readable medium or a component including a computer-readable medium. For example, the storage device may include devices or other components within a storage area network (SAN), and may be a floppy disk device, a hard disk device, an optical disk device, a tape device, a flash memory, other similar semiconductor memory devices, or an array of devices.

The network may be implemented as a wired network, such as a local area network (LAN), a wide area network (WAN), or a value-added network (VAN), or various types of wireless networks, such as a mobile radio communication network or a satellite communication network.

Although the disclosure has been described with reference to the embodiments illustrated in the drawings, these embodiments are merely exemplary. It will be understood by those skilled in the art that various modifications and variations of the embodiments are possible. That is, the scope of the disclosure is not limited to the above-described embodiments, and various modifications and alterations made by those skilled in the art based on the basic concepts defined in the following claims also fall within the scope of the claims. Therefore, the true technical protection scope of the disclosure should be determined by the technical spirit of the appended claims.

What is claimed is:

1. An image decoding method performed by a decoding apparatus, the image decoding method comprising:
obtaining reference line selection information and intra prediction mode information through a bitstream;
determining a reference line for a current block based on the reference line selection information;
deriving an intra prediction mode for the current block based on the intra prediction mode information; and
generating prediction samples for the current block based on the determined reference line and the intra prediction mode,
wherein the reference line selection information indicates one or more reference line candidates among a plurality of reference line candidates.

2. The image decoding method of claim 1, wherein the reference line selection information indicates two reference line candidates among the plurality of reference line candidates,
wherein the determined reference line includes a first reference line and a second reference line,
wherein a first prediction block is generated based on the first reference line and the intra prediction mode,
wherein a second prediction block is generated based on the second reference line and the intra prediction mode, and
wherein the prediction samples for the current block are generated based on a weighted sum of the first prediction block and the second prediction block.

3. The image decoding method of claim 1, wherein the reference line selection information indicates two reference line candidates among the plurality of reference line candidates,
wherein the determined reference line includes a first reference line and a second reference line,
wherein two reference samples of the first reference line are derived based on an intra prediction direction corresponding to the intra prediction mode,
wherein two reference samples of the second reference line are derived based on the intra prediction direction, and
wherein a prediction sample of the current block is generated based on interpolation between the two reference samples of the first reference line and the two reference samples of the second reference line.

4. The image decoding method of claim 1, wherein the generating the prediction samples for the current block based on the determined reference line and the intra prediction mode comprises:
deriving reference samples of the determined reference line;
performing filtering on the reference samples; and
generating the prediction samples for the current block based on the filtered reference samples and the intra prediction mode,
wherein the performing the filtering on the reference samples comprises:
deriving two same-line reference samples neighboring a target reference sample of the determined reference line;
deriving one neighboring-line reference sample of at least one neighboring reference line adjacent to the determined reference line; and
performing filtering on the target reference sample based on the two same-line reference samples and the one neighboring-line reference sample.

5. The image decoding method of claim 1, further comprising determining a reference line candidate set among a plurality of reference line candidate sets,
wherein the reference line selection information indicates the reference line within the determined reference line candidate set.

6. The image decoding method of claim 5, further comprising obtaining parity information from the bitstream,
wherein the reference line candidate set among the plurality of reference line candidate sets is determined based on the parity information.

7. The image decoding method of claim 6, wherein, when the parity information indicates a first value, a reference line candidate set including reference line candidates having odd line numbers is determined, and
when the parity information indicates a second value, a reference line candidate set including reference line candidates having even line numbers is determined.

8. The image decoding method of claim 6, wherein the parity information is signaled after the reference line selection information, and
wherein the parity information is signaled when a value of the reference line selection information is not 0.

9. The image decoding method of claim 6, wherein the parity information is not explicitly signaled when a size of the current block is smaller than a predetermined value.

10. The image decoding method of claim 1, wherein, when a value of the reference line selection information is 0, the intra prediction mode information includes mode set index information and mode index information, and
when the value of the reference line selection information is not 0, the intra prediction mode information includes only the mode index information among the mode set index information and the mode index information.

11. The image decoding method of claim 10, wherein, when the value of the reference line selection information is not 0, signaling of the mode set index information is omitted, and the mode index information indicates one of intra prediction mode candidates in a first mode set.

12. The image decoding method of claim 1, wherein the reference line selection information indicates a reference line candidate among a plurality of reference line candidates, and
wherein, among the plurality of reference line candidates, a number of top-left reference samples of an (n+1)-th reference line is greater than a number of top-left reference samples of an n-th reference line, and a number of top reference samples of the n-th reference line is equal to a number of top reference samples of the (n+1)-th reference line.

13. The image decoding method of claim 1, wherein the reference line selection information indicates a reference line candidate among a plurality of reference line candidates, and
wherein, among the plurality of reference line candidates, a number of top-left reference samples of an n-th reference line is equal to a number of top-left reference samples of an (n+1)-th reference line, and a number of top reference samples of the n-th reference line is equal to a number of top reference samples of the (n+1)-th reference line.

14. The image decoding method of claim 1, wherein generating the prediction samples for the current block based on the determined reference line and the intra prediction mode comprises:
deriving reference samples of the determined reference line; and
generating the prediction samples for the current block based on the derived reference samples and the intra prediction mode,
wherein, to derive the reference samples, when top reference samples of the current block are not available, the unavailable top reference samples are set to be equal to a left reference sample at coordinates (x−1−rlidx, y), and
wherein (x, y) represents a top-left sample position of the current block, and rlidx represents an index value of the reference line selection information.

15. The image decoding method of claim 1, wherein generating the prediction samples for the current block based on the determined reference line and the intra prediction mode comprises:
deriving reference samples of the determined reference line; and
generating the prediction samples for the current block based on the derived reference samples and the intra prediction mode,
wherein, when the current block is a non-square block and a height of the current block is greater than a width thereof, a first parameter is derived, and
wherein specific top reference samples having x-coordinates greater than the first parameter are set to be equal to a value of a top reference sample having an x-coordinate corresponding to the first parameter.

16. The image decoding method of claim 1, wherein the current block is a transform block,
wherein the reference line includes a left reference line and a top reference line, and
wherein, when a coding block including the transform block is located adjacent to a specific boundary, a number of the top reference line is determined differently from a number of the left reference line.

17. The image decoding method of claim 16, wherein a number of a left reference line is variably determined based on reference line selection information, and
wherein a number of a top reference line is determined as reference line 1.

18. The image decoding method of claim 1, wherein based on that an intra prediction type of a current block is IBP (intra bi-prediction) or RIP (recursive intra prediction), reference line selection information is not explicitly signaled.

19. An image encoding method performed by an encoding apparatus, the image encoding method comprising:
determining a reference line for a current block;
deriving an intra prediction mode for the current block;
generating prediction samples for the current block based on the determined reference line and the intra prediction mode;
generating reference line selection information related to the reference line;
generating intra prediction mode information related to the intra prediction mode; and
encoding image information including the reference line selection information and the intra prediction mode information,
wherein the reference line selection information indicates one or more reference line candidates among a plurality of reference line candidates.

20. A transmission method for image data, comprising:
obtaining a bitstream generated by an image encoding method, wherein the image encoding method comprises determining a reference line for a current block, deriving an intra prediction mode for the current block, generating prediction samples for the current block based on the determined reference line and the intra prediction mode, generating reference line selection information related to the reference line, generating intra prediction mode information related to the intra prediction mode, and encoding image information including the reference line selection information and the intra prediction mode information; and
transmitting the image data including the bitstream,
wherein the reference line selection information indicates one or more reference line candidates among a plurality of reference line candidates.
